(19) United States
(12) Patent Application Publication
(10) Pub. No.: US 2024/0005211 A1
(43) Pub. Date: Jan. 4, 2024

(54) DATA PROCESSING METHOD AND APPARATUS

(71) Applicant: Tencent Technlology (Shenzhen) Company Limited, Shenzhen (CN)

(72) Inventor: Jianrong WU, Shenzhen (CN)

(73) Assignee: Tencent Technlology (Shenzhen) Company Limited, Shenzhen (CN)

(21) Appl. No.: 18/368,680

(22) Filed: Sep. 15, 2023

Related U.S. Application Data
(63) Continuation of application No. PCT/CN2022/137442, filed on Dec. 8, 2022.

(30) Foreign Application Priority Data
Dec. 13, 2021 (CN) 202111521261.4

(51) Int. Cl. G06N 20/00; G06V 10/774

(52) U.S. Cl. CPC G06N 20/00; G06V 10/774; G06V 2201/07

(57) ABSTRACT

A data processing method and apparatus are provided. The method includes: predicting, based on an initial image recognition model, initial aided annotation results of original images, and acquiring initial standard annotation results; adjusting, based on a first initial standard annotation result and a first initial aided annotation result, model parameters in the initial image recognition model so as to generate an updated image recognition model; predicting, based on the updated image recognition model, an updated aided annotation result of a second original image, and acquiring an updated standard annotation result; and determining, in response to determining that the updated image recognition model satisfies a model convergence condition based on the updated aided annotation result and the updated standard annotation result, the updated image recognition model as a target image recognition model.

### RELATED APPLICATION

This application is a continuation application of PCT Patent Application No. PCT/CN2022/137442, filed on Dec. 8, 2022, which claims priority to Chinese Patent Application No. 202111521261.4, entitled “DATA PROCESSING METHOD, DEVICE, AND COMPUTER-READABLE STORAGE MEDIUM” filed to China National Intellectual Property Administration on Dec. 13, 2021, wherein the content of the above-referenced applications is incorporated herein by reference in its entirety.

### FIELD OF THE TECHNOLOGY

This disclosure relates to the field of Internet technology, and in particular to a data processing method and apparatus, a device, a storage medium, and a program product.

### BACKGROUND OF THE DISCLOSURE

At present, the annotation of target objects in images mainly includes manual annotation alone, machine annotation alone, and artificial intelligence aided annotation. The manual annotation alone means that there is no model assistance in annotation, and the annotation depends on the recognition of target objects by the annotator. The machine annotation alone means that there is no manual intervention in annotation, and a prediction result of an artificial intelligence model is used as the annotation result. The artificial intelligence aided annotation means that in annotation, the artificial intelligence model predicts an image and generates a prediction result, and the annotator annotates the target object in the image in cooperation with the prediction result.

In the related artificial intelligence aided annotation, the annotator is often only a user of the artificial intelligence model and does not participate in the update of the artificial intelligence model, which results in a failure to update the model in time, and finally affects the accuracy of aided annotation. In addition, in the related artificial intelligence aided annotation methods, there is a lack of a link of re-checking the existing annotation results, which results in a failure to update the existing annotation results. Existing annotation results with low accuracy, if present, would continue to be used in subsequent training or use.

### SUMMARY

The disclosure provide a data processing method and apparatus, a device, a storage medium, and a program product, which help improve the recognition capability of an image recognition model and improve the accuracy of an annotation result.

In one aspect, an embodiment of this disclosure provides a data processing method performed in a computer device, including:
predicting, based on an initial image recognition model, initial aided annotation results of original images, the original images comprising a first original image and a second original image, and the initial aided annotation results comprising a first initial aided annotation result of the first original image;
acquiring initial standard annotation results determined by correcting the initial aided annotation results, the initial standard annotation results comprising a first initial standard annotation result of the first original image and a second initial standard annotation result of the second original image;
adjusting, based on the first initial standard annotation result and the first initial aided annotation result, model parameters in the initial image recognition model so as to generate an updated image recognition model;
predicting, based on the updated image recognition model, an updated aided annotation result of the second original image;
acquiring an updated standard annotation result of the second original image by adjusting the second initial standard annotation result based on the updated aided annotation result; and
in response to determining that the updated image recognition model satisfies a model convergence condition based on the updated aided annotation result and the updated standard annotation result, determining the updated image recognition model as a target image recognition model, the target image recognition model being for generating an annotation result of a target image.

In another aspect, an embodiment of this disclosure provides a data processing apparatus, including a memory operable to store computer-readable instructions and a processor circuitry operable to read the computer-readable instructions. When executing the computer-readable instructions, the processor circuitry is configured to:
predict, based on an initial image recognition model, initial aided annotation results of original images, the original images comprising a first original image and a second original image, and the initial aided annotation results comprising a first initial aided annotation result of the first original image;
acquire initial standard annotation results determined by correcting the initial aided annotation results, the initial standard annotation results comprising a first initial standard annotation result of the first original image and a second initial standard annotation result of the second original image;
adjust, based on the first initial standard annotation result and the first initial aided annotation result, model parameters in the initial image recognition model so as to generate an updated image recognition model;
predict, based on the updated image recognition model, an updated aided annotation result of the second original image;
acquire an updated standard annotation result of the second original image by adjusting the second initial standard annotation result based on the updated aided annotation result; and
in response to determining that the updated image recognition model satisfies a model convergence condition based on the updated aided annotation result and the updated standard annotation result, determine the updated image recognition model as a target image recognition model, the target image recognition model being for generating an annotation result of a target image.

In another aspect, an embodiment of this disclosure provides a non-transitory machine-readable media, having instructions stored on the machine-readable media. When being executed, the instructions are configured to cause a machine to:
predict, based on an initial image recognition model, initial aided annotation results of original images, the original images comprising a first original image and a second original image, and the initial aided annotation results comprising a first initial aided annotation result of the first original image;
acquire initial standard annotation results determined by correcting the initial aided annotation results, the initial standard annotation results comprising a first initial standard annotation result of the first original image and a second initial standard annotation result of the second original image;
adjust, based on the first initial standard annotation result and the first initial aided annotation result, model parameters in the initial image recognition model so as to generate an updated image recognition model;
predict, based on the updated image recognition model, an updated aided annotation result of the second original image;
acquire an updated standard annotation result of the second original image by adjusting the second initial standard annotation result based on the updated aided annotation result; and
in response to determining that the updated image recognition model satisfies a model convergence condition based on the updated aided annotation result and the updated standard annotation result, determine the updated image recognition model as a target image recognition model, the target image recognition model being for generating an annotation result of a target image.

### BRIEF DESCRIPTION OF THE DRAWINGS

In order to illustrate the technical solutions in the embodiments of this disclosure or in the related art more clearly, the following briefly introduces the accompanying drawings for describing the embodiments or the related art. Apparently, the accompanying drawings in the following description show merely some embodiments of this disclosure, and a person of ordinary skill in the art may still derive other drawings from the accompanying drawings without creative efforts.

FIG. 1 is a schematic diagram of a system architecture according to an embodiment of this disclosure.

FIG. 2 is a flow diagram of a data processing method according to an embodiment of this disclosure.

FIG. 3 is a schematic diagram of a data processing scene according to an embodiment of this disclosure.

FIG. 4 is a schematic diagram of a data processing scene according to an embodiment of this disclosure.

FIG. 5 is a schematic diagram of a data processing scene according to an embodiment of this disclosure.

FIG. 6 is a flow diagram of a data processing method according to an embodiment of this disclosure.

FIG. 7 is a flow diagram of a data processing method according to an embodiment of this disclosure.

FIG. 8 is a flow diagram of a data processing method according to an embodiment of this disclosure.

FIG. 9 is a structural diagram of a data processing apparatus according to an embodiment of this disclosure.

FIG. 10 is a structural diagram of a computer device according to an embodiment of this disclosure.

### DESCRIPTION OF EMBODIMENTS

In conjunction with the drawings in the embodiments of this disclosure, the technical solutions in the embodiments of this disclosure will be clearly and fully described below. Apparently, the embodiments described are only some, but not all embodiments of this disclosure. Based on the embodiments of this disclosure, all other embodiments obtained by a person of ordinary skill in the art without inventive effort shall fall within the protection scope of this disclosure.

In order to facilitate understanding, some terms are first briefly explained as follows.

Artificial intelligence (AI) is a theory, method, technology, and application system that utilizes a digital computer or digital computer-controlled machine to simulate, extend, and expand human intelligence, perceive the environment, acquire knowledge, and use knowledge to obtain optimal results. In other words, AI is a comprehensive technology in computer science and attempts to understand the essence of intelligence and produce a new intelligent machine that can react in a manner similar to human intelligence. AI is to study the design principles and implementation methods of various intelligent machines, and to enable the machines to have the functions of perception, reasoning, and decision-making.

The AI technology is a comprehensive discipline, and relates to a wide range of fields including both hardware-level technologies and software-level technologies. The basic AI technologies generally include technologies such as sensors, dedicated AI chips, cloud computing, distributed storage, big data processing technology, operation/interaction systems, and electromechanical integration. AI software technologies mainly include computer vision, speech processing, natural language processing, machine learning/deep learning, automatic driving, and intelligent transportation.

Computer vision (CV) is a science that studies how to make machines “see”. More specifically, it refers to replacing human eyes with cameras and computers for machine vision, such as object recognition and measurement, and further performing graphics processing, so as to generate, by computer processing, images that are more suitable for observation of human eyes or for transmission to the instrument for detection. As a scientific discipline, CV studies related theories and technologies and attempts to establish an AI system that can obtain information from images or multidimensional data. CV technology generally includes image processing, image recognition, image semantic understanding, image retrieval, OCR, video processing, video semantic understanding, video content/behavior recognition, 3D object reconstruction, 3D technology, virtual reality, augmented reality, simultaneous localization and mapping, automatic driving, intelligent transportation, as well as common biometric feature recognition technologies such as face recognition and fingerprint recognition. In an embodiment of this disclosure, CV technology may be used for recognizing a target object (e.g., a human, dog, cat, bird, etc.) in an image and delineate and annotate the target object.

Machine learning (ML) is a multi-field interdisciplinary subject, involving probability theory, statistics, approximation theory, convex analysis, algorithmic complexity theory, and other disciplines. ML specializes in studying how a computer simulates or implements a human learning behavior to acquire new knowledge or skills, and reorganize an existing knowledge structure, so as to keep improving its performance. ML is the core of AI and the fundamental way to impart computers intelligence, which is applied in various fields of AI. ML and deep learning generally include technologies such as an artificial neural network, a belief network, reinforcement learning, transfer learning, inductive learning, and learning from demonstrations. In an embodiment of this disclosure, both the initial image recognition model and the updated image recognition model are AI models based on machine learning technology, which can be used for image recognition.

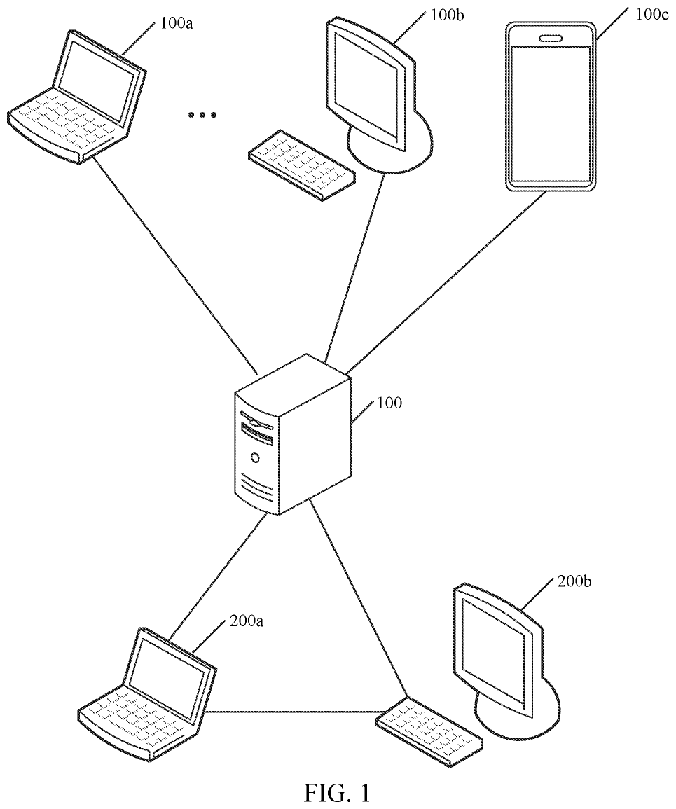

Reference may be made to FIG. 1, which is a schematic diagram of a system architecture according to an embodiment of this disclosure. As shown in FIG. 1, the system may include a traffic server 100, an annotation terminal cluster, a first check terminal 200a, and a second check terminal 200b. The annotation terminal cluster may include: an annotation terminal 100a, an annotation terminal 100b, . . . , and an annotation terminal 100c. It is to be understood that the system described above may include one or more annotation terminals, and the quantity of annotation terminals is not limited in this disclosure. The system described above may include one or more first check terminals and may also include one or more second check terminals, and the embodiment of this disclosure does not limit quantities of first check terminals and second check terminals.

The annotation terminal cluster may include annotation terminals corresponding to one or more annotation users. The traffic server 100 may be a device that acquires an initial candidate annotation result and an updated candidate annotation result (same as the candidate annotation results described below) provided by the annotation terminals. The first check terminal may be a check terminal which checks at least two candidate annotation results. The second check terminal may be a check terminal that checks target candidate annotation results.

There may be communication connections in the annotation terminal cluster, for example, a communication connection between the annotation terminal 100a and the annotation terminal 100b, and a communication connection between the annotation terminal 100a and the annotation terminal 100c. Meanwhile, there may be a communication connection between any annotation terminal in the annotation terminal cluster and the traffic server 100, for example, a communication connection between the annotation terminal 100a and the traffic server 100. There may be a communication connection between any annotation terminal in the annotation terminal cluster described above and the check terminal (including the first check terminal 200a and the second check terminal 200b) described above, for example, a communication connection between the annotation terminal 100a and the first check terminal 200a, a communication connection between the annotation terminal 100b and the first check terminal 200a, and a communication connection between the annotation terminal 100b and the second check terminal 200b.

There may be a communication connection between the first check terminal 200a and the second check terminal 200b. There may be a communication connection between any check terminal (including the first check terminal 200a and the second check terminal 200b) and the traffic server 100, for example, a communication connection between the first check terminal 200a and the traffic server 100.

The communication connection described above is not limited to a connection mode, and can be directly or indirectly connected via a wired communication mode, directly or indirectly connected via a wireless communication mode, and connected via other modes, which is not limited in this disclosure.

It is to be understood that an application client may be installed on each of the annotation terminals in the annotation terminal cluster shown in FIG. 1 which, when running in each of the annotation terminals, may perform data interaction with the traffic server 100 shown in FIG. 1 described above, i.e., the communication connection described above. The application client may be an application client with a function of annotating a target object in an image, such as a short video application, a video application, a live broadcast application, a social application, an instant messaging application, a game application, a music application, a shopping application, a novel application, a payment application, and a browser. The application client may be a standalone client or an embedded sub-client integrated in a client (e.g., a social client, an educational client, and a multimedia client), which is not limited herein. For a social application, for example, the traffic server 100 may be a set of multiple servers including a background server and a data processing server corresponding to the social application. Therefore, each annotation terminal can perform data transmission with the traffic server 100 via an application client corresponding to the social application. For example, each annotation terminal can upload a local image thereof to the traffic server 100 via the application client of the social application, and the traffic server 100 can further issue the image to a check terminal or transmit same to a cloud server.

It is to be understood that in the detailed description of this disclosure, data related to user information (e.g., initial standard annotation results in this disclosure) and the like needs to be approved or agreed upon by the user when the embodiments of this disclosure are applied to a specific product or technology, and the collection, use, and processing of related data need to comply with relevant laws, regulations, and standards of relevant countries and regions.

In order to facilitate subsequent understanding and description, the embodiment of this disclosure may select one of the annotation terminals in the annotation terminal cluster shown in FIG. 1 as a target annotation terminal, e.g., the annotation terminal 100a. Upon acquiring the initial aided annotation results for the original images transmitted by the traffic server 100 and receiving an object annotation instruction for the original images, the annotation object (i.e., the annotation user) corresponding to the annotation terminal 100a may use the initial aided annotation results as reference annotation results and perform annotation operations on the reference annotation results, for example, operations such as adding an annotation of the target object, deleting an annotation of the non-target object, modifying a wrong annotation of the target object, and confirming an annotation of the target object, and then the annotation terminal 100a may generate an initial candidate annotation result of the original images and transmit the initial candidate annotation result to the traffic server 100. The initial aided annotation results described above are obtained by predicting image features of the original images based on the initial image recognition model, and include an initial aided annotation region for the target object in the original images and an initial aided object label for the initial aided annotation region. The initial candidate annotation result includes an initial candidate annotation region for annotating the target object and an initial candidate object label for annotating the initial candidate annotation region.

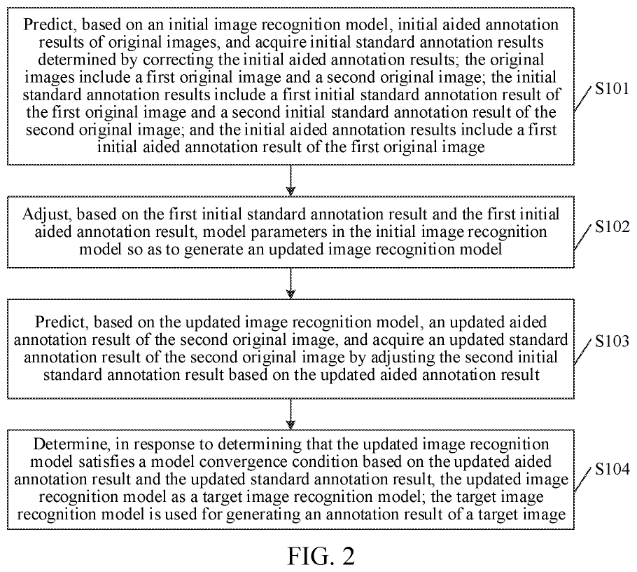

Further, upon receiving the initial candidate annotation result transmitted by the annotation terminal 100a, the traffic server 100 may obtain initial standard annotation results based on the initial candidate annotation result. The original images include a first original image and a second original image, and the initial standard annotation results include a first initial standard annotation result of the first original image and a second initial standard annotation result of the second original image. The initial aided annotation results include a first initial aided annotation result of the first original image. Further, the traffic server 100 adjusts, based on the first initial standard annotation result and the first initial aided annotation result, model parameters in the initial image recognition model so as to generate an updated image recognition model, thereby updating the initial image recognition model. Further, the traffic server 100 predicts, based on the updated image recognition model, an updated aided annotation result of the second original image, and acquires an updated standard annotation result obtained by adjusting the second initial standard annotation result based on the updated aided annotation result, thereby updating the annotation result of the annotated second original image (i.e., the second initial standard annotation result). Subsequently, the traffic server 100 determines, in response to determining that the updated image recognition model satisfies a model convergence condition based on the updated aided annotation result and the updated standard annotation result, the updated image recognition model as a target image recognition model, the target image recognition model being used for generating a target aided annotation result of the target image. The functions of the first check terminal 200a and the second check terminal 200b are described in step S103 in an embodiment corresponding to FIG. 2 below, which is not detailed here.

Optionally, if the initial image recognition model described above is stored locally in the annotation terminal 100a, the annotation terminal 100a may acquire the initial aided annotation results of the original images via the local initial image recognition model, and then generate the initial standard annotation results based on the initial aided annotation results. Likewise, if the updated image recognition model described above is stored locally in the annotation terminal 100a, the annotation terminal 100a may acquire the updated aided annotation result of the second original image via the local updated image recognition model, and then generate the updated standard annotation result based on the updated aided annotation result, with the remaining processes the same as the processes described above, which are therefore not detailed herein, with reference to the description above.

It is to be understood that since training the initial image recognition model and the updated image recognition model involves a lot of off-line calculations, both the initial image recognition model and the updated image recognition model local to the annotation terminal 100a may be transmitted to the annotation terminal 100a after being trained by the traffic server 100.

The traffic server 100, the annotation terminal 100a, the annotation terminal 100b, . . . , and the annotation terminal 100c, the first check terminal 200a, and the second check terminal 200b described above can all be block chain nodes in a block chain network. The data described throughout the text (such as the initial image recognition model, the original data, and the initial standard annotation results) may be stored in a manner that a block chain node generates a block based on the data and adds the block to the block chain for storage.

Block chain is a new application mode of computer technology, such as distributed data storage, point-to-point transmission, consensus mechanism, and encryption algorithm, and it is mainly used for sorting data in a time sequence and encrypting it into a ledger, such that it cannot be manipulated or forged, and at the same time, the data can be verified, stored, and updated. Block chain is essentially a decentralized database, and each node in the database stores an identical block chain, and a block chain network can distinguish nodes into core nodes, data nodes, and light nodes. The core nodes, data nodes, and light nodes form block chain nodes together. The core nodes are responsible for the consensus of the whole block chain network, i.e., the core nodes are consensus nodes in the block chain network. The flow of writing the transaction data in the block chain network into the ledger may be as follows. A data node or a light node in the block chain network acquires the transaction data, and transmits the transaction data in the block chain network (i.e., the nodes transmit in a relay manner) until a consensus node receives the transaction data. The consensus node then packages the transaction data into a block, and performs consensus on the block, and after the consensus is completed, the transaction data is written into the ledger. Here, the original data and the initial standard annotation results are used for exemplifying the transaction data, and after reaching the consensus on the transaction data, the traffic server 100 (a block chain node) generates a block based on the transaction data and stores the block into the block chain network. With regard to the reading of the transaction data (i.e., the original data and the initial standard annotation results), a block chain node in the block chain network may acquire the block containing the transaction data, and further acquire the transaction data in the block.

It is to be understood that the method provided by the embodiment of this disclosure may be performed by a computer device, including but not limited to an annotation terminal or a traffic server. The traffic server above may be an independent physical server, a server cluster or distributed system formed by a plurality of physical servers, or a cloud server that provides basic cloud computing services, such as cloud databases, cloud services, cloud computing, cloud functions, cloud storage, network services, cloud communication, middleware services, domain name services, security services, CDN, big data, and artificial intelligence platforms. The annotation terminals include, but are not limited to mobile phones, computers, intelligent speech interaction devices, intelligent appliances, vehicle-mounted terminals, etc. The annotation terminal and the traffic server may be directly or indirectly connected by wired or wireless means, which is not limited in the embodiments of this disclosure.

Further, reference may be made to FIG. 2, which is a flow diagram of a data processing method according to an embodiment of this disclosure. The data processing method may be performed by a traffic server (e.g., the traffic server 100 shown in FIG. 1 described above), may be performed by a terminal device (e.g., the terminal device 200a shown in FIG. 1 described above), or may be performed alternately by the traffic server and the terminal device. For ease of understanding, the embodiment of this disclosure is described with the method being performed by a traffic server. As shown in FIG. 2, the data processing method may include at least the following steps S101-S104.

Step S101: Predict, based on an initial image recognition model, initial aided annotation results of original images, and acquire initial standard annotation results determined by correcting the initial aided annotation results; the original images include a first original image and a second original image; the initial standard annotation results include a first initial standard annotation result of the first original image and a second initial standard annotation result of the second original image; and the initial aided annotation results include a first initial aided annotation result of the first original image.

In one embodiment, step S101 includes the following operations: acquiring the original images; the original images including a target object; inputting the original images into the initial image recognition model, and acquiring image features of the original images in the initial image recognition model; determining, based on the image features, an initial region recognition feature of the target object and an initial object recognition feature of the target object; generating, based on the initial region recognition feature, an initial aided annotation region for the target object, and generating, based on the initial object recognition feature, an initial aided object label for the initial aided annotation region; and determining the initial aided annotation region and the initial aided object label as the initial aided annotation results.

The initial image recognition model refers to an AI model used for recognizing the target object in the original images, and the embodiment of this disclosure does not limit the model type of the initial image recognition model. The initial image recognition model may be determined according to practical application scenes, including but not limited to convolutional neural networks (CNN), fully convolutional networks (FCN), and residual networks (Res-Net).

The embodiment of this disclosure does not limit the quantity of the original images which is at least two, and does not limit the image type of the original images which may be any image type. The embodiment of this disclosure does not limit the object type of the target object which may be any object type, such as a human, a bicycle, a table, and a medical endoscope object, and may be set according to practical application scenes. In addition, the embodiment of this disclosure does not limit the quantity of the target object. For example, when the target object is a human, there may be no target object in the original images, or at least one target object in the original images. It is to be understood that the target object may include one or more types of objects, e.g., the target object may include a bicycle or a bicycle and a human. In one embodiment, the original images are medical images and the target object is a medical detection target, i.e., the target in the medical images.

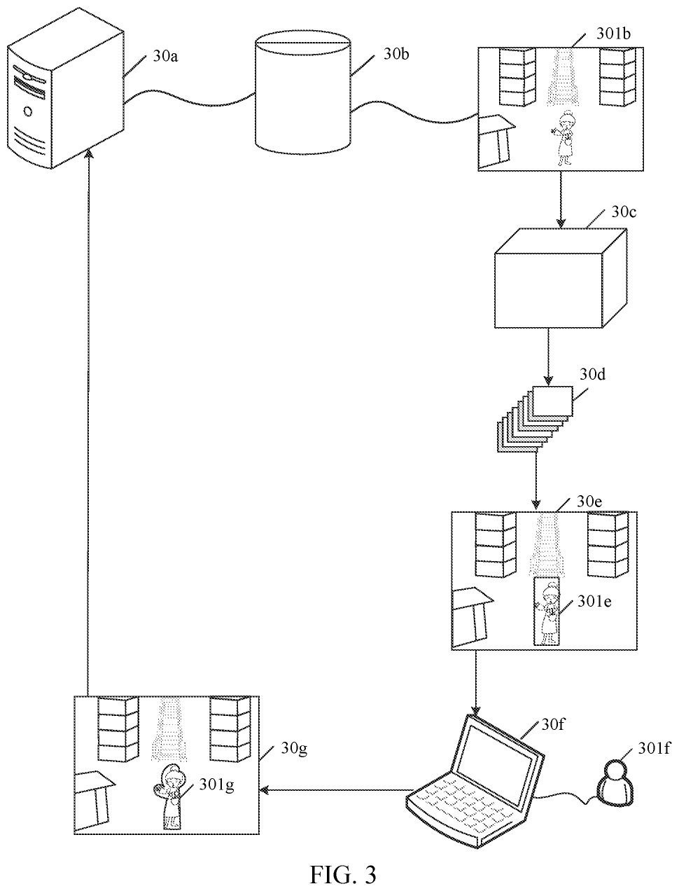

In order to facilitate understanding, reference is further made to FIG. 3, which is a schematic diagram of a data processing scene according to an embodiment of this disclosure. As shown in FIG. 3, the traffic server 30a may be the same as the traffic server 100 in FIG. 1, and the annotation terminal 30f may be any annotation terminal in the annotation terminal cluster in FIG. 1. The traffic server 30a may include an image database 30b for storing original images, as well as data associated with the original images, including but not limited to an initial image recognition model 30c. In the embodiment of this disclosure, the target object is set as a human.

Referring back to FIG. 3, the traffic server 30a inputs the first original image 301b in the image database 30b into the initial image recognition model 30c, and image features 30d of the first original image 301b may be acquired in the initial image recognition model 30c. Further, the traffic server 30a may determine an initial region recognition feature of the target object (for example, a human) and an initial object recognition feature of the target object based on the image features 30d; generate an initial aided annotation region for the target object based on the initial region recognition feature, such as the annotation region in an initial aided annotation image 30e in FIG. 3, and generate an initial aided object label for the initial aided annotation region based on the initial object recognition feature. The object label is set as a human, for example. The traffic server 100 may display the initial aided annotation image 30e in the drawing, which carries the first initial aided annotation result 301e for the first original image 301b. It is to be understood that the annotation result in this disclosure (including the initial aided annotation results and the initial standard annotation results) includes an annotation region for the target object and an object label for the target object.

Further, the traffic server 30a transmits the initial aided annotation image 30e carrying the first initial aided annotation result 301e to the annotation terminal 30f, and the annotation object 301f may correct the first initial aided annotation result 301e, for example, viewing the original image 301b and the initial aided annotation image 30f through the annotation application software installed on the annotation terminal 30f. The annotation object 301f may first confirm whether the original image 301b contains a human, and if so, the initial aided annotation region in the first initial aided annotation result 301e may be viewed. If the initial aided annotation region is approved, the annotation terminal 30f may determine the first initial aided annotation result 301e as the initial candidate annotation result (because there is only one target object, the initial aided object label is default to the object label of the target object). If the initial aided annotation region is not approved by the annotation object 301f, the location and shape of the target object are annotated by a polygon. In annotation, the annotation object 301f is required to be as close to the edge of the target object as possible, and the target object is all contained in the region, and the annotated region may be referred to as a region of interest (ROI). Optionally, the annotation object 301f modifies the initial aided annotation region to obtain the initial candidate annotation result. As shown in FIG. 3, the annotation terminal 30f may display an initial candidate annotation image 30g, which may display the initial candidate annotation result 301g.

Further, the annotation terminal 30f returns the initial candidate annotation image 30g carrying the initial candidate annotation result 301g to the traffic server 100. The embodiment of this disclosure does not limit the quantity of annotation objects for independent annotations, and there may be one or more annotation objects. In this step, the generation process of the second initial standard annotation result is exemplified with one annotation object (e.g., the annotation object 301f in FIG. 3). Reference may be made to the description in step S103 below for independent annotations of a plurality of annotation objects, separately, which has the same process as the step above, only differing in the processed data, and is therefore not detailed herein.

Referring back to FIG. 3, upon acquiring the initial candidate annotation result 301g, the traffic server 100 determines same as a first initial standard annotation result of the first original image 301b, and may store the first initial standard annotation result and the first original image 301b in the image database 30b in association.

The image database 30b may be a database dedicated for storing images by the traffic server 30a, and the image database 30b described above may be regarded as an electronic file cabinet—a place for storing electronic files (this disclosure may include original images, initial aided annotation results, and initial standard annotation results, etc.). The traffic server 30a may perform operations such as addition, query, update, and deletion on the original images, the initial aided annotation results, and the initial standard annotation results in the files. The so-called “database” is a collection of data that is stored together in a manner that may be shared with multiple users, has as little redundancy as possible, and is independent of the applications.

FIG. 3 is exemplified as generating the first initial aided annotation result 301e and the first initial standard annotation result of the first original image 301b. It is to be understood that the process of generating an initial aided annotation result and an initial standard annotation result of the remaining original image (a second original image) is the same as the process described above, only differing in the processed image, and is therefore not detailed herein.

Step S102: Adjust, based on the first initial standard annotation result and the first initial aided annotation result, model parameters in the initial image recognition model so as to generate an updated image recognition model.

The embodiment of this disclosure may be applied to various scenes such as cloud technology, AI, intelligent traffic, and aided driving. In recent years, with the breakthrough of new-generation AI technologies represented by deep learning, revolutionary progresses have been made in the field of automatic recognition of medical images, AI oriented to medical images may aid real-time in detection and classification of lesions, which is expected to help clinicians improve the quality of examination and reduce the missed diagnosis of lesions.

An excellent image recognition model relies on a large number of representative high-quality annotation data, and the quality of data annotation determines the stability and accuracy of an algorithm model. However, different modal data and different disease lesions show apparent differences and complexity among individuals, so it is necessary to continuously update the existing image recognition model, and further update the annotated data. Based on this, an embodiment of this disclosure provides an AI aided annotation method based on bidirectional quality control, which is intended to improve the accuracy and efficiency of annotation.

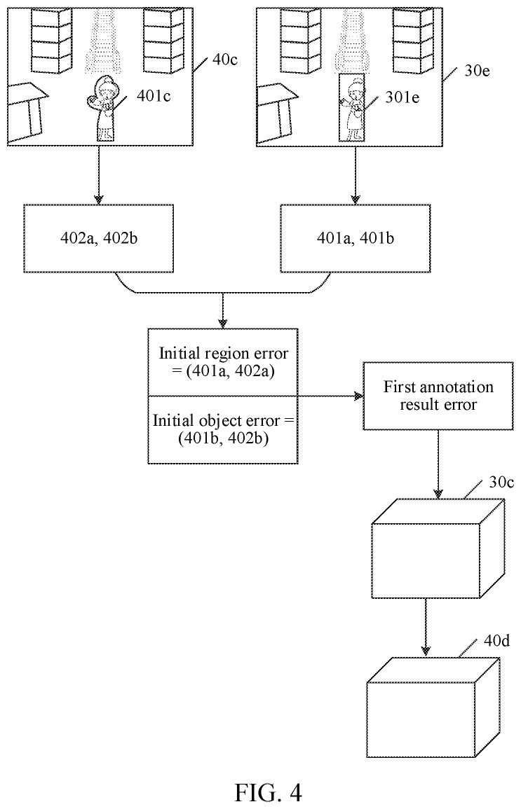

Reference is further made to FIG. 4, which is a schematic diagram of a data processing scene according to an embodiment of this disclosure. As shown in FIG. 4, an initial aided annotation image 30e includes a first initial aided annotation result 301e, and the first initial aided annotation result 301e includes a first annotation region (same as an initial aided annotation region 401a in FIG. 4) for a target object and a first object label (same as an initial aided object label 401b in FIG. 4) for the first annotation region. An initial standard annotation image 40c includes a first initial standard annotation result 401c, and the first initial standard annotation result 401c includes a second annotation region (same as an initial standard annotation region 402a in FIG. 4) for the target object and a second object label (same as an initial standard object label 402b in FIG. 4) for the second annotation region.

The traffic server determines an initial region error between the initial aided annotation region 401a and the initial standard annotation region 402a, and determines an initial object error between the initial aided object label 401b and the initial standard object label 402b. Further, weighted summation is performed on the initial region error and the initial object error to obtain a first annotation result error. The traffic server adjusts the model parameters in the initial image recognition model 30c based on the first annotation result error so as to generate an updated image recognition model 40d.

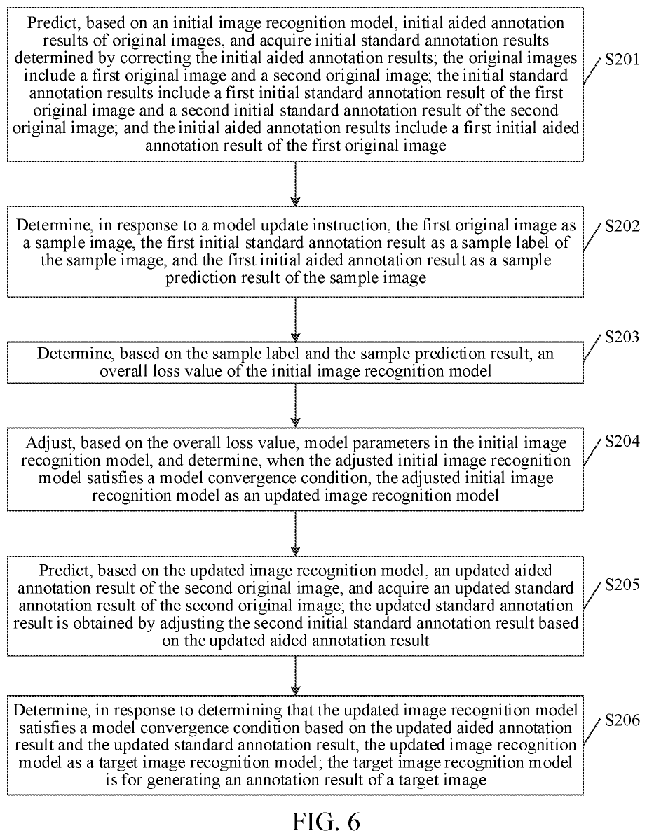

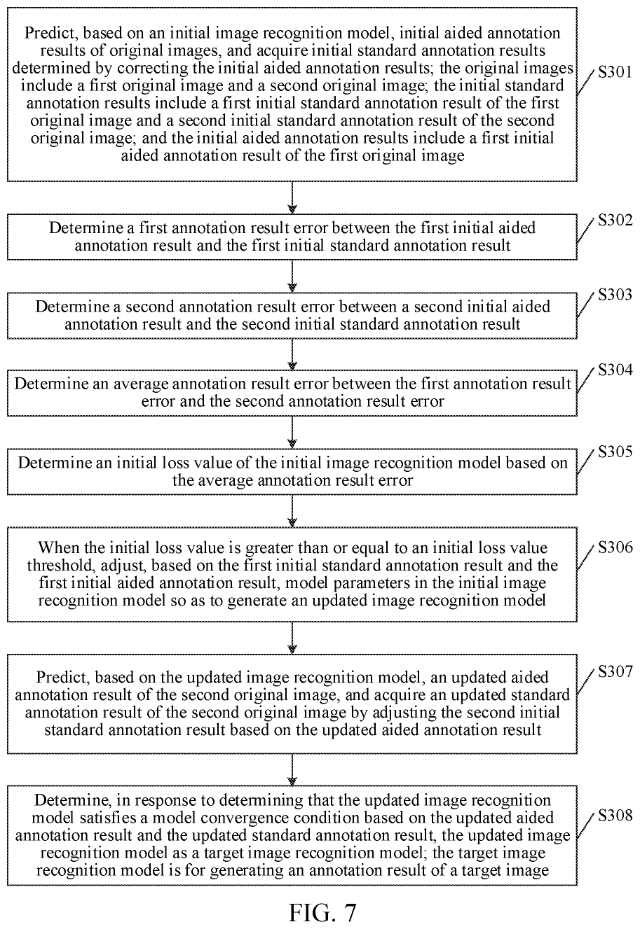

The embodiment of this disclosure does not limit the update condition of the initial image recognition model 30c, which may be that the traffic server responds to a model update instruction for the initial image recognition model 30c. For this scene, reference may be made to the description of step S202 in an embodiment corresponding to FIG. 6 below, which is not detailed herein. The update condition of the initial image recognition model 30c may also be that the result error between the initial aided annotation result and the initial standard annotation result in step S101 above reaches an initial loss value threshold. For this scene, reference may be made to the descriptions of steps S302-S306 in an embodiment corresponding to FIG. 7 below, which is not detailed herein.

In summary, the embodiment of this disclosure may determine the first initial standard annotation result and the first initial aided annotation result based on requirements of the annotation object, and thus may perform personalized update on the initial image recognition model. In other words, the embodiment of this disclosure may specifically train the model for personalized needs (e.g., for specific recognition of medical images by physicians) to improve the accuracy of object recognition in personalized scenes. For example, the target object includes a plurality of object types that may include a first target object (such as a malignant tumor) and a second target object (such as a benign tumor). The prediction accuracy for the first target object is lower than the prediction accuracy for the second target object of the initial image recognition model. Therefore, the initial standard annotation result including the first target object may be used as a first initial standard annotation result, and the initial aided annotation result including the first target object may be used as a first initial aided annotation result. In this case, model parameters in the initial image recognition model are adjusted based on the first initial standard annotation result and the first initial aided annotation result described above, so as to generate an updated image recognition model for the first target object, thereby improving the prediction accuracy for the first target object. Thus, the embodiment of this disclosure may improve the accuracy of hospital testing in medical scenes. The updated image recognition model does not change the prediction accuracy for the second target object.

Step S103: Predict, based on the updated image recognition model, an updated aided annotation result of the second original image, and acquire an updated standard annotation result of the second original image; the updated standard annotation result is obtained by adjusting the second initial standard annotation result based on the updated aided annotation result.

Specifically, the updated aided annotation result is transmitted to at least two annotation terminals. In this way, the at least two annotation terminals separately adjust the second initial standard annotation result based on the updated aided annotation result so as to obtain candidate annotation results of the second original image. The candidate annotation results returned by the at least two annotation terminals are acquired. At least two candidate annotation results separately include candidate annotation regions for annotating the target object in the second original image. Region quantities corresponding to the candidate annotation regions included separately in the at least two candidate annotation results are determined. Initial check annotation results for the at least two candidate annotation results are determined based on at least two region quantities. The updated standard annotation result is acquired based on the initial check annotation results.

The specific process of determining initial check annotation results for the at least two candidate annotation results based on at least two region quantities may include: comparing the at least two region quantities; the at least two region quantities including a region quantity Bₐ; a being a positive integer, and a being less than or equal to a result quantity of the at least two candidate annotation results; determining, when there is a region quantity different from the region quantity Bₐ in the remaining region quantities, the at least two candidate annotation results separately as the initial check annotation results; the remaining region quantities including region quantities other than the region quantity Bₐ among the at least two region quantities; acquiring, when the remaining region quantities are all the same as the region quantity Bₐ, candidate annotation regions separately included in every two candidate annotation results in the at least two candidate annotation results; and determining coincidence degrees between the candidate annotation regions separately included in every two candidate annotation results, and determining the initial check annotation results based on the coincidence degrees. In one embodiment, the coincidence degree of two candidate annotation regions is, for example, a coincidence degree between two pieces of location information of the two candidate annotation regions, and the coincidence degree between the two pieces of location information is, for example, a ratio of an intersection to a union of the two pieces of location information. Here, the location information of the candidate annotation region may characterize a location of the candidate annotation region in an image in which it is located.

The at least two candidate annotation results further separately include candidate object labels for annotating the included candidate annotation regions. The specific process of determining the initial check annotation results based on the coincidence degrees may include: determining, when at least one of the coincidence degrees is less than a coincidence degree threshold, the at least two candidate annotation results separately as the initial check annotation results; dividing, when each of the coincidence degrees is equal to or greater than the coincidence degree threshold, same candidate object labels in the at least two candidate annotation results into a same object label group so as to obtain n object label groups; n being a positive integer; and determining the initial check annotation results based on the n object label groups.

The specific process of determining the initial check annotation results based on the n object label groups may include: counting object label quantities of the candidate object labels separately included in the n object label groups, and acquiring a maximum object label quantity from the object label quantities separately corresponding to the n object label groups; determining quantity ratios between the maximum object label quantity and the object label quantities corresponding to the at least two candidate annotation results; comparing the quantity ratios with a quantity ratio threshold, and determining, when the quantity ratios are less than the quantity ratio threshold, the at least two candidate annotation results separately as the initial check annotation results; determining, when the quantity ratios are equal to or greater than the quantity ratio threshold, an object label group corresponding to the maximum object label quantity as a target object label group; and acquiring target candidate annotation results from candidate annotation results associated with the target object label group, and determining the target candidate annotation results as the initial check annotation results.

The specific process of acquiring the updated standard annotation result based on the initial check annotation results may include: transmitting, when the initial check annotation results are the at least two candidate annotation results, the initial check annotation results to a first check terminal, such that the first check terminal determines check annotation results to be transmitted to a second check terminal based on the at least two candidate annotation results; the second check terminal being configured to return the updated standard annotation result based on the check annotation results; and transmitting, when the initial check annotation results are the target candidate annotation results, the initial check annotation results to the second check terminal, such that the second check terminal returns the updated standard annotation result based on the target candidate annotation results.

The description of predicting, based on the updated image recognition model, an updated aided annotation result of the second original image may refer to the description of predicting, based on an initial image recognition model, initial aided annotation results of original images in step S101 above. The data processing processes of the two are the same, only differing in that the updated image recognition model is a model obtained after the update of the initial image recognition model, and therefore the description is not repeated here.

The process of the traffic server acquiring the updated standard annotation result is substantially the same as the process of acquiring the initial standard annotation results, and therefore the process of an annotation terminal adjusting the second initial standard annotation result based on the updated aided annotation result to obtain the updated standard annotation result is not detailed herein, and reference may be made to the description in step S101 above.

Optionally, in order to ensure data annotation quality and reduce the differences among individual annotation objects, the annotation process may include independent annotations of a plurality of annotation objects. Therefore, the traffic server may transmit the updated aided annotation result to annotation terminals corresponding to at least two annotation objects, such that the annotation terminals corresponding to the at least two annotation objects separately adjust the second initial standard annotation result based on the updated aided annotation result so as to obtain candidate annotation results of the second original image.

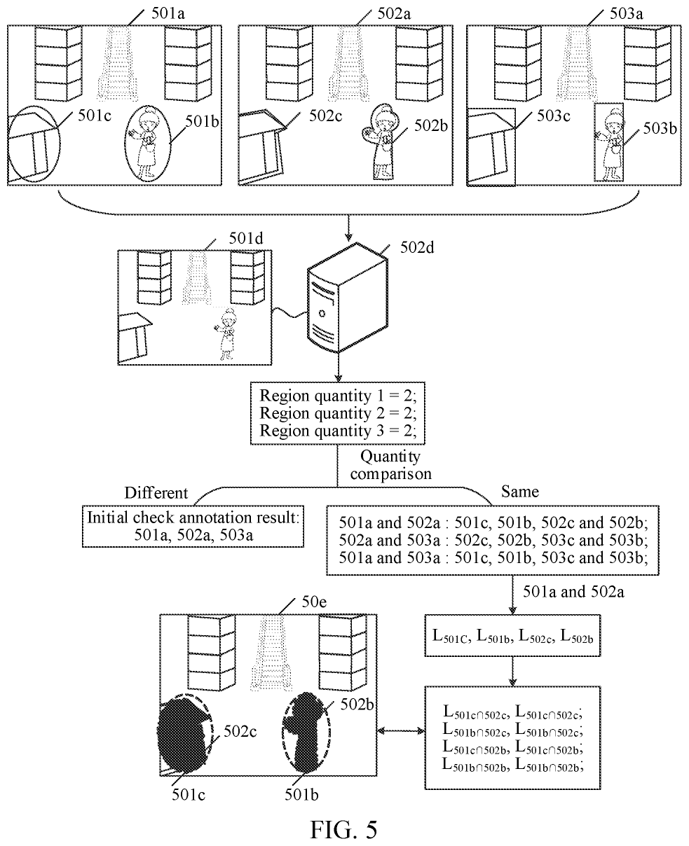

Reference may be made to FIG. 5, which is a schematic diagram of an image processing scene according to an embodiment of this disclosure. As shown in FIG. 5, the embodiment of this disclosure sets the quantity of updated candidate annotation images to three, i.e., the updated candidate annotation image 501a, the updated candidate annotation image 502a, and the updated candidate annotation image 503a in FIG. 5, and reference may be made to this embodiment when the quantity of at least two updated candidate annotation images is equal to two or another number. As shown in FIG. 5, the second original image 501d may include objects such as a house, a pedestrian, an escalator, or a building, and the target object is set to include a pedestrian and a house in this embodiment. The traffic server 502d acquires the updated candidate annotation image 501a, the updated candidate annotation image 502a, and the updated candidate annotation image 503a separately provided by three annotation objects. The three updated candidate annotation images described above are all generated based on the updated aided annotation result and the second initial standard annotation result. For example, the updated candidate annotation image 501a is an image obtained by the annotation object 101A adjusting the second initial standard annotation result based on the updated aided annotation result, and the updated candidate annotation image 502a is an image obtained by the annotation object 102A adjusting the second initial standard annotation result based on the updated aided annotation result.

As shown in FIG. 5, the candidate annotation result corresponding to the updated candidate annotation image 501a includes a candidate annotation result 501c annotating a house and a candidate annotation result 501b annotating a pedestrian, and therefore the candidate annotation result corresponding to the updated candidate annotation image 501a includes two candidate annotation regions. The candidate annotation result corresponding to the updated candidate annotation image 502a includes a candidate annotation result 502c annotating a house and a candidate annotation result 502b annotating a pedestrian, and therefore the candidate annotation result corresponding to the updated candidate annotation image 502a includes two candidate annotation regions. The candidate annotation result corresponding to the updated candidate annotation image 503a includes a candidate annotation result 503c annotating a house and a candidate annotation result 503b annotating a pedestrian, and therefore the candidate annotation result corresponding to the updated candidate annotation image 503a includes two candidate annotation regions.

Referring back to FIG. 5, the traffic server 502d determines region quantities corresponding to the candidate annotation regions separately included in the three candidate annotation results (i.e., the three updated candidate annotation images). Obviously, in FIG. 5, the three region quantities are the same, all being two, and in this case, the traffic server 502d needs to determine the coincidence degrees between each candidate annotation region in each updated candidate annotation image and candidate annotation regions in the other updated candidate region images, and then determine the initial check annotation results based on the coincidence degrees.

It is to be understood that there is no difference in the three updated candidate annotation images in FIG. 5 except for the candidate annotation results separately included in the three updated candidate annotation images (as the three updated candidate annotation images are all generated based on the second original image 501d). Therefore, the coordinates separately generated by using the upper left corners of the three images described above (i.e., the updated candidate annotation image 501a, the updated candidate annotation image 502a, and the updated candidate annotation image 503a) as coordinate origins, a direction from the origin to the right as an x-axis, and a direction down the origin as a y-axis are the same. Therefore, the location information separately corresponding to the target object in the three images is the same. For convenience of description, the coincidence degrees between the candidate annotation regions in the updated candidate annotation image 501a and the candidate annotation regions in the updated candidate annotation image 502a are determined, for example, and the coincidence degrees between candidate annotation regions separately included in the other images may be understood with reference to the following.

Based on the coordinates described above, the traffic server 502d acquires the location information L_{501c} of the candidate annotation result 501c and the location information L_{501b} of the candidate annotation result 501b in the updated candidate annotation image 501a, and acquires the location information L_{502c} of the candidate annotation result 502c and location information L_{502b} of the candidate annotation result 502b in the updated candidate annotation image 502a. The traffic server 502d determines a location information intersection L_{501c∩502c} of the location information L_{501c} of the candidate annotation result 501c with the location information L_{502c} of the candidate annotation result 502c, and determines a location information union L_{501c∪502c} of the location information L_{501c} with the location information L_{502c}. The traffic server 502d determines a location information intersection L_{501b∩502c} of the location information L_{501b} of the candidate annotation result 501b with the location information L_{502c} of the candidate annotation result 502c, and determines a location information union L_{501b∪502c} of the location information L_{501b} with the location information L_{502c}. The traffic server 502d determines a location information intersection L_{501c∩502b} of the location information L_{501c} of the candidate annotation result 501c with the location information L_{502b} of the candidate annotation result 502b, and determines a location information union L_{501c∪502b} of the location information L_{501c} with the location information L_{502b}. The traffic server 502d determines a location information intersection L_{501b∩502b} of the location information L_{501b} of the candidate annotation result 501c with the location information L_{502b} of the candidate annotation result 502b, and determines a location information union L_{501b∪502b} of the location information L_{501b} with the location information L_{502b}.

For example, a first coincidence degree of the candidate annotation result 501c in the updated candidate annotation image 501a (same as the coincidence degree of the candidate annotation region included in the candidate annotation result 501c) is determined below, and the determination of a first coincidence degree of the candidate annotation result 501b in the updated candidate annotation image 501a may refer to the following process.

The traffic server 502d may determine a candidate coincidence degree C_{(501c,502c)} between the candidate annotation result 501c and the candidate annotation result 502c according to Formula (1).

$${C}_{( 501 c , 502 c )} = \frac{{ROI}_{501 c} ⋂ {ROI}_{502 c}}{{ROI}_{501 c} ⋃ {ROI}_{502 c}} \qquad ( 1 )$$

In the formula, ROI_{501c} may represent a candidate annotation region of the candidate annotation result 501c and may be determined by the location information L_{501c}, ROI_{502c} may represent a candidate annotation region of the candidate annotation result 502c and may be determined by the location information L_{502c}, ROI_{501c} ∩ROI_{502c} may represent an intersection area of the candidate annotation region of the candidate annotation result 501c with the candidate annotation region of the candidate annotation result 502c and may be determined by the location information intersection L_{501c∩502c}, and ROI_{501c} ∪ROI_{502c} may represent a union area of the candidate annotation region of the candidate annotation result 501c with the candidate annotation region of the candidate annotation result 502c and may be determined by the location information union L_{501c∪502c}.

The traffic server 502d may determine a candidate coincidence degree C_{(501c,502b)} between the candidate annotation result 501c and the candidate annotation result 502b according to Formula (2).

$${C}_{( 501 c , 502 b )} = \frac{{ROI}_{501 c} ⋂ {ROI}_{502 b}}{{ROI}_{501 c} ⋃ {ROI}_{502 b}} \qquad ( 2 )$$

In the formula, ROI_{502b} may represent a candidate annotation region of the candidate annotation result 502b and may be determined by the location information L_{502b}, ROI_{501c} ∩ROI_{502b} may represent an intersection area of the candidate annotation region of the candidate annotation result 501c with the candidate annotation region of the candidate annotation result 502b and may be determined by the location information intersection L_{501c∩502b}, and ROI_{501c} ∪ROI_{502b} may represent a union area of the candidate annotation region of the candidate annotation result 501c and the candidate annotation region of the candidate annotation result 502b and may be determined by the location information union L_{501c∪502b}.

The traffic server 502d compares the candidate coincidence degree C_{(501c,502c)} with the candidate coincidence degree C_{(501c,502b)}. For the updated candidate annotation image 501a and the updated candidate annotation image 502a, it is obvious that there is no intersection area between the candidate annotation result 501c and the candidate annotation result 502b, and therefore the first coincidence degree of the candidate annotation result 501c is the candidate coincidence degree C_{(501c,502c)}.

For example, a second coincidence degree of the candidate annotation result 502b in the updated candidate annotation image 502a is determined below, and the determination of a second coincidence degree of the candidate annotation result 502c in the updated candidate annotation image 502a may refer to the following process.

The traffic server 502d may determine a candidate coincidence degree C_{(501b,502b)} between the candidate annotation result 502b and the candidate annotation result 501b according to Formula (3).

$${C}_{( 501 b , 502 b )} = \frac{{ROI}_{501 b} ⋂ {ROI}_{502 b}}{{ROI}_{501 b} ⋃ {ROI}_{502 b}} \qquad ( 3 )$$

In the formula, ROI_{501b} may represent a candidate annotation region of the candidate annotation result 501c and may be determined by the location information L_{501b}, ROI_{501b} ∩ROI_{502b} may represent an intersection area of the candidate annotation region of the candidate annotation result 501b with the candidate annotation region of the candidate annotation result 502b and may be determined by the location information intersection L_{501b∩502b}, and ROI_{501b} ∪ROI_{502b} may represent a union area of the candidate annotation region of the candidate annotation result 501b and the candidate annotation region of the candidate annotation result 502b and may be determined by the location information union L_{501b∪502b}.

The traffic server 502d compares the candidate coincidence degree C_{(501b,502b)} with the candidate coincidence degree C_{(501c,502b)}. For the updated candidate annotation image 501a and the updated candidate annotation image 502a, it is obvious that there is no intersection area between the candidate annotation result 501c and the candidate annotation result 502b, and therefore the second coincidence degree of the candidate annotation result 502b is the candidate coincidence degree C_{(501b,502b)}.

The traffic server 502d determines the first coincidence degree of each candidate annotation region (including the candidate annotation result 501c and the candidate annotation result 501b) in the updated candidate annotation image 501a and the second coincidence degree of each candidate annotation region (including the candidate annotation result 502c and the candidate annotation result 502b) in the updated candidate annotation image 502a as coincidence degrees between the candidate annotation regions separately included in the updated candidate annotation image 501a and the updated candidate annotation image 502a.

Referring back to FIG. 5, based on the coincident areas between the candidate annotation regions separately included in the updated candidate annotation image 501a and the updated candidate annotation image 502a, the traffic server 502d may display the coincident area image 50e, where a black area between the candidate annotation result 501c and the candidate annotation result 502c is the coincident area therebetween, and a black area between the candidate annotation result 501b and the candidate annotation result 502b is the coincident area therebetween.

The traffic server 502d compares the coincidence degrees described above with a coincidence degree threshold, and if at least one of the coincidence degrees is less than the coincidence degree threshold, the at least two candidate annotation results (i.e., the candidate annotation results separately included in the three updated candidate annotation images) are separately determined as the initial check annotation results. If each of the coincidence degrees described above is greater than or equal to the coincidence degree threshold, candidate object labels (including candidate object labels separately included in the candidate annotation result 501c and the candidate annotation result 501b) are acquired from the candidate annotation results included in the updated candidate annotation image 501a, candidate object labels (including candidate object labels separately included in the candidate annotation result 502c and the candidate annotation result 502b) are acquired from the candidate annotation results included in the updated candidate annotation image 502a, and candidate object labels (including candidate object labels separately included in the candidate annotation result 503c and the candidate annotation result 503b) are acquired from the candidate annotation results included in the updated candidate annotation image 503a. The traffic server 502d groups the same candidate object labels in the candidate object labels separately included in the three updated candidate annotation images into a same object label group so as to obtain n object label groups. The object label quantities of the candidate object labels separately included in the n object label groups are counted. A maximum object label quantity is acquired from the object label quantities separately corresponding to the n object label groups. Quantity ratios between the maximum object label quantity and the object label quantities corresponding to the at least two candidate annotation results are determined. The quantity ratios are compared with a quantity ratio threshold, and when the quantity ratios are less than the quantity ratio threshold, the candidate annotation results separately corresponding to the three updated candidate annotation images are all determined as the initial check annotation results. When the quantity ratios are equal to or greater than the quantity ratio threshold, an object label group corresponding to the maximum object label quantity is determined as a target object label group. Target candidate annotation results are acquired from candidate annotation results associated with the target object label group, and the target candidate annotation results are determined as the initial check annotation results.

After determining the initial check annotation results, the traffic server needs to transmit the initial check annotation results to a check terminal (including a first check terminal and a second check terminal), such that the check terminal confirms the results and returns an updated standard annotation result. If the initial check annotation results are at least two candidate annotation results, the traffic server transmits the initial check annotation results to the first check terminal (same as the first check terminal 200a described above in FIG. 1). The first check terminal described above has an arbitration function throughout data processing.

After the first check terminal acquires at least two candidate annotation results, an arbitration object corresponding thereto may view the second original image and the at least two candidate annotation results. If the arbitration object confirms that none of the at least two candidate annotation results is desirable, region annotation and object annotation may be performed on the second original image. The process of the arbitration object annotating the second original image is the same as the process of the annotation object annotating the first original image, and therefore, reference may be made to the annotation described in step S101 above. Subsequently, the arbitration object may transmit the re-annotated check annotation result thereof as an arbitration result to the second check terminal (same as the second check terminal 200b described above in FIG. 1) via the first check terminal, such that the check object corresponding to the second check terminal checks the arbitration result.

If the arbitration object approves one of the at least two candidate annotation results, the approved candidate annotation result may be directly transmitted to the second check terminal as the arbitration result, such that the check object checks the arbitration result.

When the initial check annotation results are the target candidate annotation results, the initial check annotation results are transmitted to the second check terminal, and the second check terminal described above has a check function throughout image processing. After the second check terminal acquires the target candidate annotation results, the check object may check the image via the second check terminal.

The check object may store the target candidate annotation results or the arbitration result transmitted by the first check terminal, if approved, in an image database (same as the image database 30b in FIG. 3) associated with the traffic server. If the check object does not approve the target candidate annotation results or the arbitration result transmitted by the first check terminal, existing annotation data may be discarded, and other annotation objects may be allowed to perform region annotation and object annotation on the second original image. Alternatively, the second original image may be re-forwarded to the first check terminal, such that the arbitration object annotates the second original image. Subsequently, the check object checks the regenerated check annotation result, and the check process is the same as the check process described above, which is therefore not detailed herein.

In summary, in this step, quality control may be performed on the second original image with an existing annotation result through the updated initial image recognition model (i.e., the updated image recognition model), such that the existing annotation result may be dynamically updated, thereby improving the accuracy of target recognition.

Step S104: Determine, in response to determining that the updated image recognition model satisfies a model convergence condition based on the updated aided annotation result and the updated standard annotation result, the updated image recognition model as a target image recognition model; the target image recognition model is used for generating an annotation result of a target image.

Specifically, the second original image includes a target object. The updated aided annotation result includes an updated aided annotation region for the target object and an updated aided object label for the updated aided annotation region. The updated standard annotation result includes an updated standard annotation region for the target object and an updated standard object label for the updated standard annotation region. An updated region loss value between the updated aided annotation region and the updated standard annotation region is determined. An updated object loss value between the updated aided object label and the updated standard object label is determined. Weighted summation is performed on the updated region loss value and the updated object loss value to obtain an updated loss value of the updated image recognition model. When the updated loss value is greater than or equal to an updated loss value threshold, it is determined that the updated image recognition model does not satisfy the model convergence condition, and model parameters in the updated image recognition model continue to be adjusted. When the updated loss value is less than the updated loss value threshold, it is determined that the updated image recognition model satisfies the model convergence condition, and the updated image recognition model is determined as the target image recognition model.

The original images further include a third original image. The initial standard annotation results further include a third initial standard annotation result of the third original image. The initial aided annotation results further include a third initial aided annotation result of the third original image. The specific process of continuing to adjust model parameters in the updated image recognition model may include: determining an adjusted loss value based on the third initial standard annotation result and the third initial aided annotation result; performing weighted summation on the adjusted loss value and the updated loss value to obtain a target loss value; and adjusting the model parameters in the updated image recognition model based on the target loss value.

The embodiment of this disclosure does not limit the quantities separately corresponding to the first original image, the second original image, and the third original image, which may be any number, and may be set according to practical application scenes. It is to be understood that the first original image and the second original image are different from each other, and the second original image and the third original image are different from each other. Optionally, if the updated loss value is less than the updated loss value threshold, and the annotation object transmits, via the annotation terminal, an instruction to continue updating the model, the traffic server may keep the update processing on the updated image recognition model with a process the same as the subsequent process where the updated loss value is equal to or greater than the updated loss value threshold, which is therefore not detailed herein.

The traffic server may determine the third original image based on the updated loss value, and the specific process for determination may be as follows. The target object may include at least two target objects, and the at least two target objects may include a first target object. It is to be understood that the updated loss value may be obtained by averaging a first updated loss value for the first target object and remaining updated loss values for the remaining target objects. The remaining target objects include target objects other than the first target object among the at least two target objects. Therefore, the traffic server may determine a first loss value ratio of the first updated loss value to the updated loss value, and acquire, based on the first loss value ratio and the training sample quantity (equal to the quantity of the third original images), original images including the first target object and original images including the remaining target objects from the original images, and determine the two types of original images described above as the third original images. For example, if the training sample quantity is equal to 200 and the first loss value ratio is 0.8, the traffic server may randomly extract 160 images including the first target object from the original images, and similarly randomly extract the remaining images from the original images, and determine the extracted images including the first target object and the remaining images as the third original images.

In an embodiment of this disclosure, a computer device may use a first initial standard annotation result and a first initial aided annotation result as a training sample set to update an initial image recognition model, i.e., adjusting model parameters to obtain an updated image recognition model. It is to be understood that the process can not only realize the model update, but also determine the orientation of the model update based on the training sample set. Further, an updated aided annotation result of the second original image is predicted based on the updated image recognition model, and an updated standard annotation result obtained by adjusting the second initial standard annotation result based on the updated aided annotation result is acquired, thereby updating the second initial standard annotation result. Further, when the updated image recognition model is determined as the target image recognition model, a target aided annotation result of the target image is generated by using the target image recognition model. It may be seen from the above that the embodiment of this disclosure can not only update the initial image recognition model based on the training sample set, so as to improve the recognition capability of the updated image recognition model, but also update the second initial standard annotation result through the updated image recognition model, so as to improve the accuracy of the updated standard annotation result. Therefore, this disclosure enables bidirectional update of the image recognition model and the annotation result.

Reference may be made to FIG. 6, which is a flow diagram of a data processing method according to an embodiment of this disclosure. The method may be performed by a traffic server (e.g., the traffic server 100 shown in FIG. 1 described above), may be performed by an annotation terminal (e.g., the annotation terminal 100a shown in FIG. 1 described above), or may be performed alternately by the traffic server and the annotation terminal. As shown in FIG. 6, the method may include at least the following steps.

Step S201: Predict, based on an initial image recognition model, initial aided annotation results of original images, and acquire initial standard annotation results determined by correcting the initial aided annotation results; the original images include a first original image and a second original image; the initial standard annotation results include a first initial standard annotation result of the first original image and a second initial standard annotation result of the second original image; and the initial aided annotation results include a first initial aided annotation result of the first original image.

The specific implementation of step S201 may refer to step S101 in the embodiment corresponding to FIG. 2 above, which is not detailed herein.

Step S202: Determine, in response to a model update instruction, the first original image as a sample image, the first initial standard annotation result as a sample label of the sample image, and the first initial aided annotation result as a sample prediction result of the sample image.

Step S203: Determine, based on the sample label and the sample prediction result, an overall loss value of the initial image recognition model.

Step S204: Adjust, based on the overall loss value, model parameters in the initial image recognition model, and determine, when the adjusted initial image recognition model satisfies a model convergence condition, the adjusted initial image recognition model as an updated image recognition model.

In conjunction with the description of steps S202 to S204, the traffic server currently uses the initial image recognition model to predict original images in the image database, and generates initial aided annotation results corresponding to the original images, and acquires initial standard annotation results determined based on the initial aided annotation results. In the embodiment of this disclosure, the determination of an average annotation result error between the initial standard annotation results and the initial aided annotation results is not detailed, and reference may be made to the description of steps S302 to S304 in the embodiment corresponding to FIG. 7 below.

In this case, an initial loss value generated based on the average annotation result error between the initial standard annotation results and the initial aided annotation results is less than an initial loss value threshold, and when a model update instruction is acquired, the traffic server responds to the model update instruction. Optionally, the model update instruction carries training sample information, and the training sample information may include at least two object labels and training sample quantities separately corresponding to the at least two object labels. For example, the at least two object labels include a first object label and a second object label, and the model update instruction carries a first training sample quantity for the first object label and a second training sample quantity for the second object label. Then the traffic server may acquire, from the initial standard annotation results, an initial standard annotation result of which the annotation result quantity is equal to the first training sample quantity and which includes the first object label, and determine the acquired initial standard annotation result as a first initial standard annotation result. The traffic server acquires, from the initial aided annotation results, an initial aided annotation result corresponding to the first initial standard annotation result as a first initial aided annotation result. Further, the traffic server determines the first initial standard annotation result as a sample label of the sample image, determines the first initial aided annotation result as a sample prediction result of the sample image, determines an error between the sample label and the sample prediction result, determines the error as an overall loss value of the initial image recognition model, adjusts model parameters in the initial image recognition model by using the overall loss value, and determines, when the adjusted initial image recognition model satisfies a model convergence condition, the adjusted initial image recognition model as the updated image recognition model.

It may be seen from the above that the embodiment of this disclosure can not only update the initial image recognition model, but also determine the update orientation by the traffic object, thereby improving the update efficiency as well as the prediction accuracy of the model.

Step S205: Predict, based on the updated image recognition model, an updated aided annotation result of the second original image, and acquire an updated standard annotation result; the updated standard annotation result is obtained by adjusting the second initial standard annotation result based on the updated aided annotation result.

Step S206: Determine, in response to determining that the updated image recognition model satisfies a model convergence condition based on the updated aided annotation result and the updated standard annotation result, the updated image recognition model as a target image recognition model; the target image recognition model is used for generating a target aided annotation result of a target image.

The specific implementation of steps S205-S206 may refer to steps S103-S104 in the embodiment corresponding to FIG. 2 above, which is not detailed herein.

In an embodiment of this disclosure, a computer device may use a first initial standard annotation result and a first initial aided annotation result as a training sample set to update an initial image recognition model, i.e., adjusting model parameters to obtain an updated image recognition model. It is to be understood that the process can not only realize the model update, but also determine the orientation of the model update based on the training sample set. Further, an updated aided annotation result of the second original image is predicted based on the updated image recognition model, and an updated standard annotation result obtained by adjusting the second initial standard annotation result based on the updated aided annotation result is acquired, thereby updating the second initial standard annotation result. Further, when the updated image recognition model is determined as the target image recognition model, a target aided annotation result of the target image is generated by using the target image recognition model. It may be seen from the above that the embodiment of this disclosure can not only update the initial image recognition model based on the training sample set, so as to improve the recognition capability of the updated image recognition model, but also update the second initial standard annotation result through the updated image recognition model, so as to improve the accuracy of the updated standard annotation result. Therefore, this disclosure enables bidirectional update of the image recognition model and the annotation result.

Reference may be made to FIG. 7, which is a flow diagram of a data processing method according to an embodiment of this disclosure. The method may be performed by a traffic server (e.g., the traffic server 100 shown in FIG. 1 described above), may be performed by an annotation terminal (e.g., the annotation terminal 100a shown in FIG. 1 described above), or may be performed alternately by the traffic server and the annotation terminal. As shown in FIG. 7, the method may include at least the following steps.

Step S301: Predict, based on an initial image recognition model, initial aided annotation results of original images, and acquire initial standard annotation results determined based on the initial aided annotation results; the original images include a first original image and a second original image; the initial standard annotation results include a first initial standard annotation result of the first original image and a second initial standard annotation result of the second original image; and the initial aided annotation results include a first initial aided annotation result of the first original image.

The specific implementation of step S301 may refer to step S101 in the embodiment corresponding to FIG. 2 above, which is not detailed herein.

Step S302: Determine a first annotation result error between the first initial aided annotation result and the first initial standard annotation result.

Step S303: Determine a second annotation result error between a second initial aided annotation result and the second initial standard annotation result.

Step S304: Determine an average annotation result error between the first annotation result error and the second annotation result error.

Step S305: Determine an initial loss value of the initial image recognition model based on the average annotation result error.

Step S306: When the initial loss value is greater than or equal to an initial loss value threshold, adjust, based on the first initial standard annotation result and the first initial aided annotation result, model parameters in the initial image recognition model so as to generate an updated image recognition model.

Step S307: Predict, based on the updated image recognition model, an updated aided annotation result of the second original image, and acquire an updated standard annotation result; the updated standard annotation result is obtained by adjusting the second initial standard annotation result based on the updated aided annotation result.

Step S308: Determine, in response to determining that the updated image recognition model satisfies a model convergence condition based on the updated aided annotation result and the updated standard annotation result, the updated image recognition model as a target image recognition model; the target image recognition model is used for generating a target aided annotation result of a target image.

The specific implementation of steps S307-S308 may refer to steps S103-S104 in the embodiment corresponding to FIG. 2 above, which is not detailed herein.

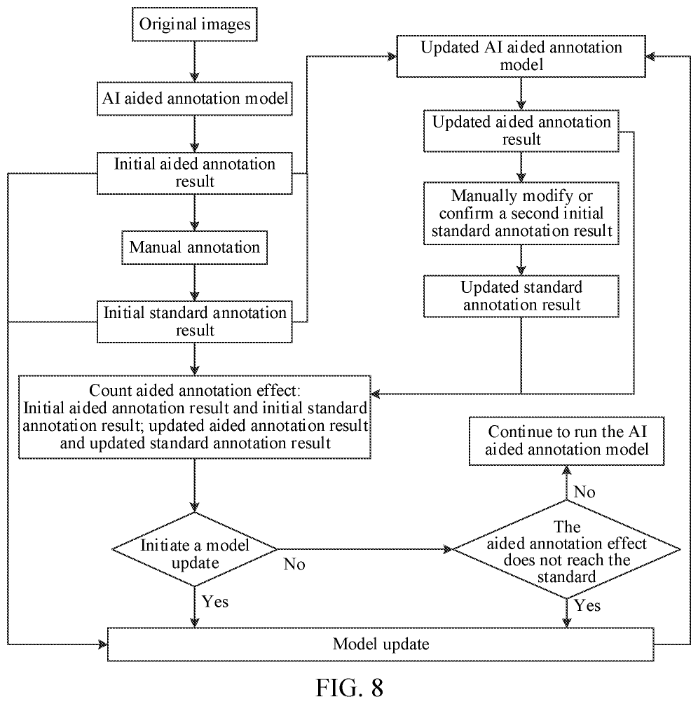

In conjunction with FIG. 2, FIG. 6, and FIG. 7, reference is further made to FIG. 8, which is a flow diagram of a data processing method according to an embodiment of this disclosure. As shown in FIG. 8, a traffic server inputs original images into an AI aided annotation model (same as the initial image recognition model described above) to obtain initial aided annotation results of the original images. The traffic server transmits the initial aided annotation results to an annotation terminal corresponding to an annotation object, such that the annotation object views the original images and the initial aided annotation results via the annotation terminal, and determines an initial candidate annotation result based on the initial aided annotation results. The traffic server acquires the initial candidate annotation result returned by the annotation terminal, and obtains initial standard annotation results based on the initial candidate annotation result, counts a result error between the initial aided annotation results and the initial standard annotation results, and determines whether to initiate a model update manually. If the model update is initiated, the traffic server updates the initial image recognition model based on the first initial standard annotation result and the first initial aided annotation result, and if the model update is not initiated, the traffic server detects whether the aided annotation effect reaches the standard, with reference to the description in FIG. 6 above. If the aided annotation effect reaches the standard, the AI aided annotation model continues to run. If the aided annotation effect does not reach the standard, the traffic server updates the initial image recognition model based on the first initial standard annotation result and the first initial aided annotation result to obtain an updated AI aided annotation model (same as the updated image recognition model described above). The traffic server re-predicts the annotated second original image through the updated image recognition model to obtain an updated aided annotation result. The traffic server transmits the updated aided annotation result to the annotation terminal corresponding to the annotation object, such that the annotation object views the updated aided annotation result via the annotation terminal, and modify or confirm the second initial standard annotation result based on the updated aided annotation result, so as to obtain a candidate annotation result. The traffic server acquires the candidate annotation result returned by the annotation terminal, and obtains an updated standard annotation result based on the candidate annotation result. The traffic server counts a result error between the updated aided annotation result and the updated standard annotation result, and determines the updated image recognition model as a target image recognition model based on the result error.

In an embodiment of this disclosure, a computer device may use a first initial standard annotation result and a first initial aided annotation result as a training sample set to update an initial image recognition model, i.e., adjusting model parameters to obtain an updated image recognition model. It is to be understood that the process can not only realize the model update, but also determine the orientation of the model update based on the training sample set. Further, an updated aided annotation result of the second original image is predicted based on the updated image recognition model, and an updated standard annotation result obtained by adjusting the second initial standard annotation result based on the updated aided annotation result is acquired, thereby updating the second initial standard annotation result. Further, when the updated image recognition model is determined as the target image recognition model, a target aided annotation result of the target image is generated by using the target image recognition model. It may be seen from the above that the embodiment of this disclosure can not only update the initial image recognition model based on the training sample set, so as to improve the recognition capability of the updated image recognition model, but also update the second initial standard annotation result through the updated image recognition model, so as to improve the accuracy of the updated standard annotation result. Therefore, this disclosure enables bidirectional update of the image recognition model and the annotation result.

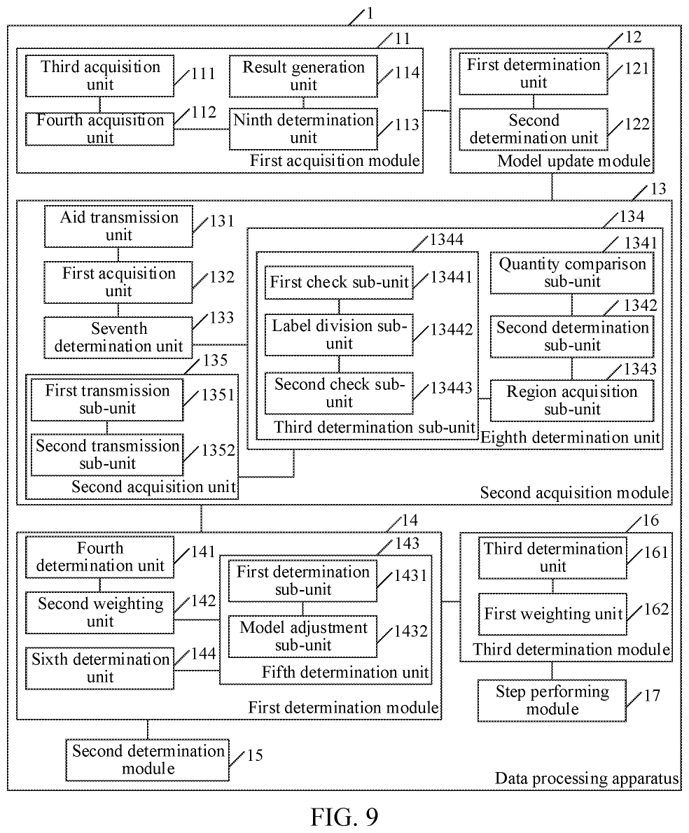

Further, reference may be made to FIG. 9, which is a structural diagram of a data processing apparatus according to an embodiment of this disclosure. The data processing apparatus described above may be a computer program (including program codes) running in a computer device. For example, the data processing apparatus is application software. The apparatus may be used for performing corresponding steps in the method provided by embodiments of this disclosure. As shown in FIG. 9, the data processing apparatus 1 may include: a first acquisition module 11, a model update module 12, a second acquisition module 13, and a first determination module 14.

The term “module” (and other similar terms such as unit, submodule, etc.) refers to computing software, firmware, hardware, and/or various combinations thereof. At a minimum, however, modules are not to be interpreted as software that is not implemented on hardware, firmware, or recorded on a non-transitory processor readable recordable storage medium. Indeed “module” is to be interpreted to include at least some physical, non-transitory hardware such as a part of a processor, circuitry, or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices. The modules can be implemented in software stored in memory or non-transitory computer-readable medium. The software stored in the memory or medium can run on a processor or circuitry (e.g., ASIC, PLA, DSP, FPGA, or any other integrated circuit) capable of executing computer instructions or computer code. The modules can also be implemented in hardware using processors or circuitry on the same or different integrated circuit.

The first acquisition module 11 is configured to predict, based on an initial image recognition model, initial aided annotation results of original images, and acquire initial standard annotation results determined by correcting the initial aided annotation results; the original images include a first original image and a second original image; the initial standard annotation results include a first initial standard annotation result of the first original image and a second initial standard annotation result of the second original image; and the initial aided annotation results include a first initial aided annotation result of the first original image.

The model update module 12 is configured to adjust, based on the first initial standard annotation result and the first initial aided annotation result, model parameters in the initial image recognition model so as to generate an updated image recognition model.

The second acquisition module 13 is configured to predict, based on the updated image recognition model, an updated aided annotation result of the second original image, and acquire an updated standard annotation result of the second original image; the updated standard annotation result is obtained by adjusting the second initial standard annotation result based on the updated aided annotation result.

The first determination module 14 is configured to determine, in response to determining that the updated image recognition model satisfies a model convergence condition based on the updated aided annotation result and the updated standard annotation result, the updated image recognition model as a target image recognition model; the target image recognition model is used for generating an annotation result of a target image.

The specific functional implementations of the first acquisition module 11, the model update module 12, the second acquisition module 13, and the first determination module 14 may refer to steps S101-S104 in the embodiment corresponding to FIG. 2 above, which is not detailed herein.

Referring back to FIG. 9, the data processing apparatus 1 may further include: a second determination module 15.

The second determination module 15 is configured to determine, in response to a model update instruction, the first original image as a sample image, the first initial standard annotation result as a sample label of the sample image, and the first initial aided annotation result as a sample prediction result of the sample image.

Then the model update module 12 includes: a first determination unit 121 and a second determination unit 122.

The first determination unit 121 is configured to determine, based on the sample label and the sample prediction result, an overall loss value of the initial image recognition model.

The second determination unit 122 is configured to adjust, based on the overall loss value, model parameters in the initial image recognition model, and determine, when the adjusted initial image recognition model satisfies a model convergence condition, the adjusted initial image recognition model as an updated image recognition model.

The specific functional implementations of the second determination module 15, the first determination unit 121, and the second determination unit 122 may refer to steps S202-S204 in the embodiment corresponding to FIG. 6 above, which is not detailed herein.

Referring back to FIG. 9, the initial aided annotation results further include a second initial aided annotation result of the second original image.

The data processing apparatus 1 may further include: a third determination module 16 and a step performing module 17.

The third determination module 16 is configured to determine a first annotation result error between the first initial aided annotation result and the first initial standard annotation result.

The third determination module 16 is further configured to determine a second annotation result error between the second initial aided annotation result and the second initial standard annotation result.

The third determination module 16 is further configured to determine an average annotation result error between the first annotation result error and the second annotation result error.

The third determination module 16 is further configured to determine an initial loss value of the initial image recognition model based on the average annotation result error.

The step performing module 17 is configured to perform, when the initial loss value is greater than or equal to an initial loss value threshold, the step of adjusting, based on the first initial standard annotation result and the first initial aided annotation result, model parameters in the initial image recognition model so as to generate an updated image recognition model.

The specific functional implementations of the third determination module 16 and the step performing module 17 may refer to steps S302-S306 in the embodiment corresponding to FIG. 7 above, which is not detailed herein.

Referring back to FIG. 9, the first original image includes a target object. The first initial aided annotation result includes a first annotation region for the target object and a first object label for the first annotation region. The first initial standard annotation result includes a second annotation region for the target object and a second object label for the second annotation region.

The third determination module 16 may include: a third determination unit 161 and a first weighting unit 162.

The third determination unit 161 is configured to determine an initial region error between the first annotation region and the second annotation region.

The third determination unit 161 is further configured to determine an initial object error between the first object label and the second object label.

The first weighting unit 162 is configured to perform weighted summation on the initial region error and the initial object error to obtain the first annotation result error.

The specific functional implementations of the third determination unit 161 and the first weighting unit 162 may refer to step S302 in the embodiment corresponding to FIG. 7 above, which is not detailed herein.

Referring back to FIG. 9, the second original image includes a target object. The updated aided annotation result includes an updated aided annotation region for the target object and an updated aided object label for the updated aided annotation region. The updated standard annotation result includes an updated standard annotation region for the target object and an updated standard object label for the updated standard annotation region.

The first determination module 14 may include: a fourth determination unit 141, a second weighting unit 142, a fifth determination unit 143, and a sixth determination unit 144.

The fourth determination unit 141 is configured to determine an updated region loss value between the updated aided annotation region and the updated standard annotation region.

The fourth determination unit 141 is configured to determine an updated object loss value between the updated aided object label and the updated standard object label.

The second weighting unit 142 is configured to perform weighted summation on the updated region loss value and the updated object loss value to obtain an updated loss value of the updated image recognition model.

The fifth determination unit 143 is configured to determine, when the updated loss value is greater than or equal to an updated loss value threshold, that the updated image recognition model does not satisfy the model convergence condition, and continue to adjust model parameters in the updated image recognition model.

The sixth determination unit 144 is configured to determine, when the updated loss value is less than the updated loss value threshold, that the updated image recognition model satisfies the model convergence condition, and determine the updated image recognition model as the target image recognition model.

The specific functional implementations of the fourth determination unit 141, the second weighting unit 142, the fifth determination unit 143, and the sixth determination unit 144 may refer to step S104 in the embodiment corresponding to FIG. 2 above, which is not detailed herein.

Referring back to FIG. 9, the original images further include a third original image. The initial standard annotation results further include a third initial standard annotation result of the third original image. The initial aided annotation results further include a third initial aided annotation result of the third original image.

The fifth determination unit 143 may include: a first determination sub-unit 1431 and a model adjustment sub-unit 1432.

The first determination sub-unit 1431 is configured to determine an adjusted loss value based on the third initial standard annotation result and the third initial aided annotation result.

The first determination sub-unit 1431 is further configured to perform weighted summation on the adjusted loss value and the updated loss value to obtain a target loss value.

The model adjustment sub-unit 1432 is configured to adjust the model parameters in the updated image recognition model based on the target loss value.

The specific functional implementations of the first determination sub-unit 1431 and the model adjustment sub-unit 1432 may refer to step S104 in the embodiment corresponding to FIG. 2 above, which is not detailed herein.

Referring back to FIG. 9, the second acquisition module 13 may include: an aid transmission unit 131, a first acquisition unit 132, a seventh determination unit 133, an eighth determination unit 134, and a second acquisition unit 135.

The aid transmission unit 131 is configured to transmit the updated aided annotation result to annotation terminals corresponding to at least two annotation objects, such that the annotation terminals corresponding to the at least two annotation objects separately adjust the second initial standard annotation result based on the updated aided annotation result so as to obtain candidate annotation results of the second original image.

The first acquisition unit 132 is configured to acquire candidate annotation results returned by the annotation terminals separately corresponding to the at least two annotation objects; at least two candidate annotation results separately include candidate annotation regions for annotating the target object in the second original image.

The seventh determination unit 133 is configured to determine region quantities corresponding to the candidate annotation regions included separately in the at least two candidate annotation results.

The eighth determination unit 134 is configured to determine initial check annotation results for the at least two candidate annotation results based on at least two region quantities.

The second acquisition unit 135 is configured to acquire the updated standard annotation result based on the initial check annotation results.

The specific functional implementations of the aid transmission unit 131, the first acquisition unit 132, the seventh determination unit 133, the eighth determination unit 134, and the second acquisition unit 135 may refer to step S103 in the embodiment corresponding to FIG. 2 above, which is not detailed herein.

Referring back to FIG. 9, the eighth determination unit 134 may include: a quantity comparison sub-unit 1341, a second determination sub-unit 1342, a region acquisition sub-unit 1343, and a third determination sub-unit 1344.

The quantity comparison sub-unit 1341 is configured to compare the at least two region quantities; the at least two region quantities include a region quantity Bₐ; a is a positive integer, and a is less than or equal to a result quantity of the at least two candidate annotation results.

The second determination sub-unit 1342 is configured to determine, when there is a region quantity different from the region quantity Bₐ in the remaining region quantities, the at least two candidate annotation results separately as the initial check annotation results; the remaining region quantities include region quantities other than the region quantity Bₐ among the at least two region quantities.

The region acquisition sub-unit 1343 is configured to acquire, when the remaining region quantities are all the same as the region quantity Bₐ, candidate annotation regions separately included in every two candidate annotation results in the at least two candidate annotation results.

The third determination sub-unit 1344 is configured to determine coincidence degrees between the candidate annotation regions separately included in every two candidate annotation results, and determine the initial check annotation results based on the coincidence degrees.

The specific functional implementations of the quantity comparison sub-unit 1341, the second determination sub-unit 1342, the region acquisition sub-unit 1343, and the third determination sub-unit 1344 may refer to step S104 in the embodiment corresponding to FIG. 2 above, which is not detailed herein.

Referring back to FIG. 9, the at least two candidate annotation results further separately include candidate object labels for annotating the included candidate annotation regions.

The third determination sub-unit 1344 may include: a first check sub-unit 13441, a label division sub-unit 13442, and a second check sub-unit 13443.

The first check sub-unit 13441 is configured to determine, when at least one of the coincidence degrees is less than a coincidence degree threshold, the at least two candidate annotation results separately as the initial check annotation results.

The label division sub-unit 13442 is configured to group, when each of the coincidence degrees is equal to or greater than the coincidence degree threshold, same candidate object labels in the at least two candidate annotation results into a same object label group so as to obtain n object label groups; n is a positive integer.

The second check sub-unit 13443 is configured to determine the initial check annotation results based on the n object label groups.

The specific functional implementations of the first check sub-unit 13441, the label division sub-unit 13442, and the second check sub-unit 13443 may refer to step S103 in the embodiment corresponding to FIG. 2 above, which is not detailed herein.

Referring back to FIG. 9, the second check sub-unit 13443 is specifically configured to count object label quantities of the candidate object labels separately included in the n object label groups, and acquire a maximum object label quantity from the object label quantities separately corresponding to the n object label groups.

The second check sub-unit 13443 is further specifically configured to determine quantity ratios between the maximum object label quantity and the object label quantities corresponding to the at least two candidate annotation results.

The second check sub-unit 13443 is further specifically configured to compare the quantity ratios with a quantity ratio threshold, and determine, when the quantity ratios are less than the quantity ratio threshold, the at least two candidate annotation results separately as the initial check annotation results.

The second check sub-unit 13443 is further specifically configured to determine, when the quantity ratios are equal to or greater than the quantity ratio threshold, an object label group corresponding to the maximum object label quantity as a target object label group.

The second check sub-unit 13443 is further specifically configured to acquire target candidate annotation results from candidate annotation results associated with the target object label group, and determine the target candidate annotation results as the initial check annotation results.

The specific functional implementation of the second check sub-unit 13443 may refer to step S103 in the embodiment corresponding to FIG. 2 above, which is not detailed herein.

Referring back to FIG. 9, the second acquisition unit 135 may include: a first transmission sub-unit 1351 and a second transmission sub-unit 1352.

The first transmission sub-unit 1351 is configured to transmit, when the initial check annotation results are the at least two candidate annotation results, the initial check annotation results to a first check terminal, such that the first check terminal determines check annotation results to be transmitted to a second check terminal based on the at least two candidate annotation results. The second check terminal is configured to return the updated standard annotation result based on the check annotation results.

The second transmission sub-unit 1352 is configured to transmit, when the initial check annotation results are the target candidate annotation results, the initial check annotation results to the second check terminal, such that the second check terminal returns the updated standard annotation result based on the target candidate annotation results.

The specific functional implementations of the first transmission sub-unit 1351 and the second transmission sub-unit 1352 may refer to step S103 in the embodiment corresponding to FIG. 2 above, which is not detailed herein.

Referring back to FIG. 9, the first acquisition module 11 may include: a third acquisition unit 111, a fourth acquisition unit 112, a ninth determination unit 113, and a result generation unit 114.

The third acquisition unit 111 is configured to acquire original images; the original images include a target object.

The fourth acquisition unit 112 is configured to input the original images into the initial image recognition model, and acquire image features of the original images in the initial image recognition model.

The ninth determination unit 113 is configured to determine, based on the image features, an initial region recognition feature of the target object and an initial object recognition feature of the target object.

The result generation unit 114 is configured to generate, based on the initial region recognition feature, an initial aided annotation region for the target object, and generate, based on the initial object recognition feature, an initial aided object label for the initial aided annotation region.

The result generation unit 114 is further configured to determine the initial aided annotation region and the initial aided object label as the initial aided annotation results.

The specific functional implementations of the third acquisition unit 111, the fourth acquisition unit 112, the ninth determination unit 113, and the result generation unit 114 may refer to step S101 in the embodiment corresponding to FIG. 2 above, which is not detailed herein.

In an embodiment of this disclosure, a computer device may use a first initial standard annotation result and a first initial aided annotation result as a training sample set to update an initial image recognition model, i.e., adjusting model parameters to obtain an updated image recognition model. It is to be understood that the process can not only realize the model update, but also determine the orientation of the model update based on the training sample set. Further, an updated aided annotation result of the second original image is predicted based on the updated image recognition model, and an updated standard annotation result obtained by adjusting the second initial standard annotation result based on the updated aided annotation result is acquired, thereby updating the second initial standard annotation result. Further, when the updated image recognition model is determined as the target image recognition model, a target aided annotation result of the target image is generated by using the target image recognition model. It may be seen from the above that the embodiment of this disclosure can not only update the initial image recognition model based on the training sample set, so as to improve the recognition capability of the updated image recognition model, but also update the second initial standard annotation result through the updated image recognition model, so as to improve the accuracy of the updated standard annotation result. Therefore, this disclosure enables bidirectional update of the image recognition model and the annotation result.

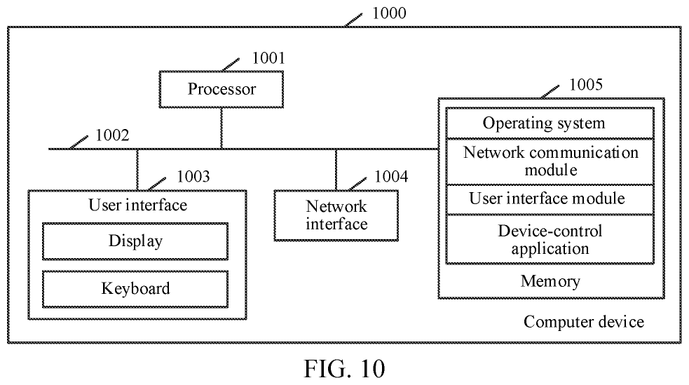

Further, reference may be made to FIG. 10, which is a structural diagram of a computer device according to an embodiment of this disclosure. As shown in FIG. 10, the computer device 1000 may include: at least one processor 1001, such as a CPU, at least one network interface 1004, a user interface 1003, a memory 1005, and at least one communication bus 1002. The communication bus 1002 is used for enabling communication connections of these components. The user interface 1003 may include a display and a keyboard, and the network interface 1004 may optionally include a standard wired interface and a wireless interface (e.g., a WI-FI interface). The memory 1005 may be a high-speed RAM memory or a non-volatile memory, such as at least one disk memory. Optionally, the memory 1005 may be at least one storage device positioned remotely from the foregoing processor 1001. As shown in FIG. 10, the memory 1005, as a computer storage medium, may include an operating system, a network communication module, a user interface module, and a device-control application.

In the computer device 1000 shown in FIG. 10, the network interface 1004 can provide a network communication function. The user interface 1003 is mainly used for providing an interface for user input. The processor 1001 may be used for invoking the device-control application stored in the memory 1005 to implement the following steps:

Predict, based on an initial image recognition model, initial aided annotation results of original images, and acquire initial standard annotation results determined based on the initial aided annotation results; the original images include a first original image and a second original image; the initial standard annotation results include a first initial standard annotation result of the first original image and a second initial standard annotation result of the second original image; and the initial aided annotation results include a first initial aided annotation result of the first original image.

Adjust, based on the first initial standard annotation result and the first initial aided annotation result, model parameters in the initial image recognition model so as to generate an updated image recognition model.

Predict, based on the updated image recognition model, an updated aided annotation result of the second original image, and acquire an updated standard annotation result; the updated standard annotation result is obtained by adjusting the second initial standard annotation result based on the updated aided annotation result.

Determine, in response to determining that the updated image recognition model satisfies a model convergence condition based on the updated aided annotation result and the updated standard annotation result, the updated image recognition model as a target image recognition model; the target image recognition model is used for generating a target aided annotation result of a target image.

It is to be understood that the computer device 1000 as described in the embodiments of this disclosure may carry out the description of the data processing method as described in the embodiments corresponding to FIG. 2, FIG. 6, FIG. 7, and FIG. 8 as well as the description of the data processing apparatus 1 as described in the embodiment corresponding to FIG. 9, which is not detailed herein. In addition, the description of beneficial effects of the same method is not detailed as well.

An embodiment of this disclosure further provides a computer-readable storage medium storing a computer program including program instructions which, when executed by a processor, implement the data processing method provided by the steps of FIG. 2, FIG. 6, FIG. 7, and FIG. 8, and reference may be made to the implementations provided by the steps of FIG. 2, FIG. 6, FIG. 7, and FIG. 8, which is not detailed herein. In addition, the description of beneficial effects of the same method is not detailed as well.

The computer-readable storage medium above may be a data processing apparatus provided by any of the preceding embodiments, or an internal storage unit of the computer device above, such as a hard disk or an internal memory of the computer device. The computer-readable storage medium may also be an external storage device of the computer device, such as a plug-in hard disk, a smart media card (SMC), a secure digital (SD) card, or a flash card provided on the computer device. Further, the computer-readable storage medium can include both the internal storage unit and the external storage device of the computer device. The computer-readable storage medium is used for storing the computer program and other programs and data required by the computer device. The computer-readable storage medium can also be used for temporarily storing data that has been or will be output.

An embodiment of this disclosure further provides a computer program product or computer program including computer instructions stored in a computer-readable storage medium. A processor of a computer device reads the computer instructions from the computer-readable storage medium, and the processor executes the computer instructions to cause the computer device to carry out the description of the data processing method as described in the embodiments corresponding to FIG. 2, FIG. 6, FIG. 7, and FIG. 8, which is not detailed herein. In addition, the description of beneficial effects of the same method is not detailed as well.

The terms “first”, “second”, and the like in the description of embodiments, claims, and drawings of this disclosure are used for distinguishing between different objects and not necessarily for describing a specific order. Furthermore, the term “include” and any variations thereof are intended to encompass a non-exclusive inclusion. For example, a process, method, apparatus, product, or device that includes a list of steps or units is not limited to the listed steps or modules, but may optionally include additional steps or modules not listed or may optionally include additional steps or units inherent to such process, method, apparatus, product, or device.

Those skilled in the art may recognize that the units and algorithm steps of the examples described in connection with the embodiments disclosed herein can be implemented in electronic hardware, computer software, or a combination thereof, and that the components and steps of the examples have been described above generally in terms of functions to clearly illustrate the interchangeability of hardware and software. Whether these functions are performed in hardware or software depends upon the particular application and design constraint imposed on the technical solution. Skilled artisans may implement the described functions in various ways for each particular application, but such an implementation is not interpreted as departing from the scope of this disclosure.

The method and the apparatus related thereto provided by embodiments of this disclosure are described with reference to method flowcharts and/or structural diagrams provided by embodiments of this disclosure, and specifically, each flow and/or block in the method flowcharts and/or structural diagrams, and combinations of flows and/or blocks in the flowcharts and/or block diagrams may be implemented by computer program instructions. These computer program instructions may be provided to a processor of a general-purpose computer, a special-purpose computer, an embedded processor, or other programmable data processing devices to produce a machine, such that the instructions, which execute via the processor of the computer or other programmable data processing devices, create means for implementing the functions specified in a flow or flows of the flowcharts and/or a block or blocks of the structural diagrams. These computer program instructions may also be stored in a computer-readable memory that can direct a computer or other programmable data processing devices to function in a particular manner such that the instructions stored in the computer-readable memory produce an article of manufacture including instruction means that implement the functions specified in a flow or flows of the flowcharts and/or a block or blocks of the structural diagrams. These computer program instructions may also be loaded onto a computer or other programmable data processing devices such that a series of operational steps are performed on the computer or other programmable devices to produce a computer-implemented process such that the instructions which execute on the computer or other programmable devices provide steps for implementing the functions specified in a flow or flows of the flowcharts and/or a block or blocks of the structural diagrams.

The above disclosures are merely preferred embodiments of this disclosure, and are of course not intended to limit the scope of claims of this disclosure, and therefore, equivalent changes made according to the claims of this disclosure are still within the scope of this disclosure.

What is claimed is:

1. A data processing method performed in a computer device, comprising:
predicting, based on an initial image recognition model, initial aided annotation results of original images, the original images comprising a first original image and a second original image, and the initial aided annotation results comprising a first initial aided annotation result of the first original image;
acquiring initial standard annotation results determined by correcting the initial aided annotation results, the initial standard annotation results comprising a first initial standard annotation result of the first original image and a second initial standard annotation result of the second original image;
adjusting, based on the first initial standard annotation result and the first initial aided annotation result, model parameters in the initial image recognition model so as to generate an updated image recognition model;
predicting, based on the updated image recognition model, an updated aided annotation result of the second original image;
acquiring an updated standard annotation result of the second original image by adjusting the second initial standard annotation result based on the updated aided annotation result; and
in response to determining that the updated image recognition model satisfies a model convergence condition based on the updated aided annotation result and the updated standard annotation result, determining the updated image recognition model as a target image recognition model, the target image recognition model being for generating an annotation result of a target image.

2. The method according to claim 1, further comprising:
determining, in response to a model update instruction, the first original image as a sample image, the first initial standard annotation result as a sample label of the sample image, and the first initial aided annotation result as a sample prediction result of the sample image; and
the adjusting the model parameters in the initial image recognition model so as to generate an updated image recognition model comprising:
determining, based on the sample label and the sample prediction result, an overall loss value of the initial image recognition model;
adjusting, based on the overall loss value, the model parameters in the initial image recognition model; and
determining, in response to the adjusted initial image recognition model satisfying a model convergence condition, the adjusted initial image recognition model as the updated image recognition model.

3. The method according to claim 1, wherein the initial aided annotation results further comprise a second initial aided annotation result of the second original image, and the method further comprises:
determining a first annotation result error between the first initial aided annotation result and the first initial standard annotation result;
determining a second annotation result error between the second initial aided annotation result and the second initial standard annotation result;
determining an average annotation result error between the first annotation result error and the second annotation result error;
determining an initial loss value of the initial image recognition model based on the average annotation result error; and
in response to the initial loss value being greater than or equal to an initial loss value threshold, adjusting, based on the first initial standard annotation result and the first initial aided annotation result, model parameters in the initial image recognition model so as to generate an updated image recognition model.

4. The method according to claim 3, wherein the first initial aided annotation result comprises a first annotation region for a target object and a first object label for the first annotation region, the first initial standard annotation result comprises a second annotation region for the target object and a second object label for the second annotation region, and the determining the first annotation result error between the first initial aided annotation result and the first initial standard annotation result comprises:
determining an initial region error between the first annotation region and the second annotation region;
determining an initial object error between the first object label and the second object label; and
performing weighted summation on the initial region error and the initial object error to obtain the first annotation result error.

5. The method according to claim 1, wherein the updated aided annotation result comprises an updated aided annotation region for a target object and an updated aided object label for the updated aided annotation region, the updated standard annotation result comprises an updated standard annotation region for the target object and an updated standard object label for the updated standard annotation region, and the determining the updated image recognition model as the target image recognition model comprises:
determining an updated region loss value between the updated aided annotation region and the updated standard annotation region;
determining an updated object loss value between the updated aided object label and the updated standard object label;
performing weighted summation on the updated region loss value and the updated object loss value to obtain an updated loss value of the updated image recognition model;
in response to the updated loss value being greater than or equal to an updated loss value threshold,
determining that the updated image recognition model fails to satisfy the model convergence condition, and
continuing to adjust model parameters in the updated image recognition model; and
in response to the updated loss value being less than the updated loss value threshold,
determining that the updated image recognition model satisfies the model convergence condition, and
determining the updated image recognition model as the target image recognition model.

6. The method according to claim 5, wherein the original images further comprise a third original image, the initial standard annotation results further comprise a third initial standard annotation result of the third original image, the initial aided annotation results further comprise a third initial aided annotation result of the third original image, and the continuing to adjust model parameters in the updated image recognition model comprises:
determining an adjusted loss value based on the third initial standard annotation result and the third initial aided annotation result;
performing weighted summation on the adjusted loss value and the updated loss value to obtain a target loss value; and
adjusting the model parameters in the updated image recognition model based on the target loss value.

7. The method according to claim 1, wherein the acquiring the updated standard annotation result of the second original image comprises:
transmitting the updated aided annotation result to at least two annotation terminals, such that the at least two annotation terminals separately adjust the second initial standard annotation result based on the updated aided annotation result so as to obtain candidate annotation results of the second original image;
acquiring at least two candidate annotation results returned by the at least two annotation terminals, the at least two candidate annotation results separately comprising candidate annotation regions for annotating a target object in the second original image;
determining region quantities corresponding to the candidate annotation regions comprised separately in the at least two candidate annotation results;
determining initial check annotation results for the at least two candidate annotation results based on at least two region quantities; and
acquiring the updated standard annotation result based on the initial check annotation results.

8. The method according to claim 7, wherein the determining the initial check annotation results for the at least two candidate annotation results based on at least two region quantities comprises:
comparing the at least two region quantities, the at least two region quantities comprising a region quantity Bₐ; a being a positive integer, and a being less than or equal to a result quantity of the at least two candidate annotation results;
determining, in response to a region quantity in remaining region quantities being different from the region quantity Bₐ, the at least two candidate annotation results separately as the initial check annotation results; the remaining region quantities comprising region quantities other than the region quantity Bₐ among the at least two region quantities;
acquiring, in response to the remaining region quantities being all same as the region quantity Bₐ, candidate annotation regions separately comprised in every two candidate annotation results in the at least two candidate annotation results; and
determining coincidence degrees between the candidate annotation regions separately comprised in every two candidate annotation results, and determining the initial check annotation results based on the coincidence degrees.

9. The method according to claim 8, wherein the at least two candidate annotation results further separately comprise candidate object labels for annotating the candidate annotation regions, and the determining the initial check annotation results based on the coincidence degrees comprises:
determining, in response to at least one of the coincidence degrees being less than a coincidence degree threshold, the at least two candidate annotation results separately as the initial check annotation results;
grouping, in response to each of the coincidence degrees being equal to or greater than the coincidence degree threshold, same candidate object labels in the at least two candidate annotation results into a same object label group so as to obtain n object label groups; n being a positive integer; and
determining the initial check annotation results based on the n object label groups.

10. The method according to claim 9, wherein the determining the initial check annotation results based on the n object label groups comprises:
counting object label quantities of the candidate object labels separately comprised in the n object label groups, and acquiring a maximum object label quantity from the object label quantities separately corresponding to the n object label groups;
determining quantity ratios between the maximum object label quantity and the object label quantities corresponding to the at least two candidate annotation results;
comparing the quantity ratios with a quantity ratio threshold, and determining, in response to the quantity ratios being less than the quantity ratio threshold, the at least two candidate annotation results separately as the initial check annotation results;
determining, in response to the quantity ratios being equal to or greater than the quantity ratio threshold, an object label group corresponding to the maximum object label quantity as a target object label group; and
acquiring target candidate annotation results from candidate annotation results associated with the target object label group, and determining the target candidate annotation results as the initial check annotation results.

11. The method according to claim 10, wherein the acquiring the updated standard annotation result based on the initial check annotation results comprises:
transmitting, in response to the initial check annotation results are the at least two candidate annotation results, the initial check annotation results to a first check terminal, such that the first check terminal determines check annotation results to be transmitted to a second check terminal based on the at least two candidate annotation results, the second check terminal being configured to return the updated standard annotation result based on the check annotation results; and
transmitting, in response to the initial check annotation results being the target candidate annotation results, the initial check annotation results to the second check terminal, such that the second check terminal returns the updated standard annotation result based on the target candidate annotation results.

12. The method according to claim 1, wherein the predicting the initial aided annotation results of original images comprises:
acquiring the original images, the original images comprising a target object;
inputting the original images into the initial image recognition model, and acquiring image features of the original images in the initial image recognition model;
determining, based on the image features, an initial region recognition feature of the target object and an initial object recognition feature of the target object;
generating, based on the initial region recognition feature, an initial aided annotation region for the target object, and generating, based on the initial object recognition feature, an initial aided object label for the initial aided annotation region; and
determining the initial aided annotation region and the initial aided object label as the initial aided annotation results.

13. A data processing apparatus, comprising:
a memory operable to store computer-readable instructions; and
a processor circuitry operable to read the computer-readable instructions, the processor circuitry when executing the computer-readable instructions is configured to:
predict, based on an initial image recognition model, initial aided annotation results of original images, the original images comprising a first original image and a second original image, and the initial aided annotation results comprising a first initial aided annotation result of the first original image;
acquire initial standard annotation results determined by correcting the initial aided annotation results, the initial standard annotation results comprising a first initial standard annotation result of the first original image and a second initial standard annotation result of the second original image;
adjust, based on the first initial standard annotation result and the first initial aided annotation result, model parameters in the initial image recognition model so as to generate an updated image recognition model;
predict, based on the updated image recognition model, an updated aided annotation result of the second original image;
acquire an updated standard annotation result of the second original image by adjusting the second initial standard annotation result based on the updated aided annotation result; and
in response to determining that the updated image recognition model satisfies a model convergence condition based on the updated aided annotation result and the updated standard annotation result, determine the updated image recognition model as a target image recognition model, the target image recognition model being for generating an annotation result of a target image.

14. The apparatus according to claim 13, wherein the processor circuitry is further configured to:
determine, in response to a model update instruction, the first original image as a sample image, the first initial standard annotation result as a sample label of the sample image, and the first initial aided annotation result as a sample prediction result of the sample image;
determine, based on the sample label and the sample prediction result, an overall loss value of the initial image recognition model;
adjust, based on the overall loss value, the model parameters in the initial image recognition model; and
determine, in response to the adjusted initial image recognition model satisfying a model convergence condition, the adjusted initial image recognition model as the updated image recognition model.

15. The apparatus according to claim 13, wherein the initial aided annotation results further comprise a second initial aided annotation result of the second original image, and the processor circuitry is further configured to:
determine a first annotation result error between the first initial aided annotation result and the first initial standard annotation result;
determine a second annotation result error between the second initial aided annotation result and the second initial standard annotation result;
determine an average annotation result error between the first annotation result error and the second annotation result error;
determine an initial loss value of the initial image recognition model based on the average annotation result error; and
in response to the initial loss value being greater than or equal to an initial loss value threshold, adjust, based on the first initial standard annotation result and the first initial aided annotation result, model parameters in the initial image recognition model so as to generate an updated image recognition model.

16. The apparatus according to claim 15, wherein the first initial aided annotation result comprises a first annotation region for a target object and a first object label for the first annotation region, the first initial standard annotation result comprises a second annotation region for the target object and a second object label for the second annotation region, the processor circuitry is configured to:
determine an initial region error between the first annotation region and the second annotation region;
determine an initial object error between the first object label and the second object label; and
perform weighted summation on the initial region error and the initial object error to obtain the first annotation result error.

17. The apparatus according to claim 13, wherein the updated aided annotation result comprises an updated aided annotation region for a target object and an updated aided object label for the updated aided annotation region, the updated standard annotation result comprises an updated standard annotation region for the target object and an updated standard object label for the updated standard annotation region, and the processor circuitry is configured to:
determine an updated region loss value between the updated aided annotation region and the updated standard annotation region;
determine an updated object loss value between the updated aided object label and the updated standard object label;
perform weighted summation on the updated region loss value and the updated object loss value to obtain an updated loss value of the updated image recognition model;
in response to the updated loss value being greater than or equal to an updated loss value threshold,
determine that the updated image recognition model fails to satisfy the model convergence condition, and
continue to adjust model parameters in the updated image recognition model; and
in response to the updated loss value being less than the updated loss value threshold,
determine that the updated image recognition model satisfies the model convergence condition, and
determine the updated image recognition model as the target image recognition model.

18. The apparatus according to claim 13, wherein the processor circuitry is further configured to:
transmit the updated aided annotation result to at least two annotation terminals, such that the at least two annotation terminals separately adjust the second initial standard annotation result based on the updated aided annotation result so as to obtain candidate annotation results of the second original image;
acquire at least two candidate annotation results returned by the at least two annotation terminals, the at least two candidate annotation results separately comprising candidate annotation regions for annotating a target object in the second original image;
determine region quantities corresponding to the candidate annotation regions comprised separately in the at least two candidate annotation results;
determine initial check annotation results for the at least two candidate annotation results based on at least two region quantities; and
acquire the updated standard annotation result based on the initial check annotation results.

19. The apparatus according to claim 13, wherein the processor circuitry is configured to:
acquire the original images, the original images comprising a target object;
input the original images into the initial image recognition model, and acquiring image features of the original images in the initial image recognition model;
determine, based on the image features, an initial region recognition feature of the target object and an initial object recognition feature of the target object;
generate, based on the initial region recognition feature, an initial aided annotation region for the target object, and generate, based on the initial object recognition feature, an initial aided object label for the initial aided annotation region; and
determine the initial aided annotation region and the initial aided object label as the initial aided annotation results.

20. A non-transitory machine-readable media, having instructions stored on the machine-readable media, the instructions configured to, when executed, cause a machine to:
predict, based on an initial image recognition model, initial aided annotation results of original images, the original images comprising a first original image and a second original image, and the initial aided annotation results comprising a first initial aided annotation result of the first original image;
acquire initial standard annotation results determined by correcting the initial aided annotation results, the initial standard annotation results comprising a first initial standard annotation result of the first original image and a second initial standard annotation result of the second original image;
adjust, based on the first initial standard annotation result and the first initial aided annotation result, model parameters in the initial image recognition model so as to generate an updated image recognition model;
predict, based on the updated image recognition model, an updated aided annotation result of the second original image;
acquire an updated standard annotation result of the second original image by adjusting the second initial standard annotation result based on the updated aided annotation result; and
in response to determining that the updated image recognition model satisfies a model convergence condition based on the updated aided annotation result and the updated standard annotation result, determine the updated image recognition model as a target image recognition model, the target image recognition model being for generating an annotation result of a target image.
